(19) United States
(12) Patent Application Publication
(10) Pub. No.: US 2017/0091010 A1
(43) Pub. Date: Mar. 30, 2017

(54) INTRODUCTION DETERMINATION PROGRAM, INTRODUCTION DETERMINATION DEVICE AND INTRODUCTION DETERMINATION METHOD

(71) Applicant: FUJITSU LIMITED, Kawasaki-shi (JP)

(72) Inventor: Ryohei Takahashi, Kobe (JP)

(73) Assignee: FUJITSU LIMITED, Kawasaki-shi (JP)

(21) Appl. No.: 15/262,083

(22) Filed: Sep. 12, 2016

(30) Foreign Application Priority Data
Sep. 28, 2015 (JP) 2015-189451

(51) Int. Cl. G06F 11/07

(52) U.S. Cl. CPC G06F 11/079; G06F 11/0709; G06F 11/0751; G06F 11/0772

(57) ABSTRACT

A non-transitory computer-readable storage medium storing therein an introduction determination program that causes a computer to execute a process includes: receiving an application introduction specification including an application to be introduced into an information processing system and an operating rate for the application, the information processing system including a plurality of information processing devices; and determining whether or not introduction of the application for each of the plurality of the information processing devices, on the basis of the application introduction specification, a first information amount required for an introduction of the application or a post-processing after the introduction, respective failure rates of the plurality of information processing devices, and respective access performance, to respective storage devices, of the plurality of information processing devices.

### CROSS-REFERENCE TO RELATED APPLICATION

This application is based upon and claims the benefit of priority of the prior Japanese Patent Application No. 2015-189451, filed on Sep. 28, 2015, the entire contents of which are incorporated herein by reference.

### FIELD

The present invention relates to an introduction determination program, an introduction determination device and an introduction determination method.

### BACKGROUND

An operator providing services to a user (simply called “operator” below) constructs, for example, a business system on which an application for providing services to the user runs (simply called “business system” below). When constructing a business system of this kind, the operator constructs the business system, for example, by a plurality of physical machines, in accordance with the number of users who use the business system, etc.

More specifically, the operator acquires information, such as the processing performance and communication performance, etc. of the physical machines. The operator then decides upon a method for introducing an application for providing the service (decides upon the physical machines on which the application is to be introduced), in such a manner that the processing load and/or communication load on the physical machines during provision of the service comes within the processing performance and/or communication performance of the physical machines. Consequently, the operator is able to make effective use of the physical resources of the physical machines (see Japanese Laid-open Patent Publication No. 2013-206051 and Japanese Laid-open Patent Publication No. 2007-310749).

### SUMMARY

According to an aspect of the embodiments, a non-transitory computer-readable storage medium storing therein an introduction determination program that causes a computer to execute a process includes: receiving an application introduction specification including an application to be introduced into an information processing system and an operating rate for the application, the information processing system including a plurality of information processing devices; and determining whether or not introduction of the application for each of the plurality of the information processing devices, on the basis of the application introduction specification, a first information amount required for an introduction of the application or a post-processing after the introduction, respective failure rates of the plurality of information processing devices, and respective access performance, to respective storage devices, of the plurality of information processing devices.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating the devices according to a first embodiment of the present invention.

FIG. 2 is a diagram illustrating a specific example of an application introduced into the physical machine group 2.

FIG. 3 is a diagram illustrating the hardware configuration of the management device 1.

FIG. 4 is a block diagram of the functions of the management device 1.

FIG. 5 is a block diagram of the information stored in the information storage region 130 of the management device 1.

FIG. 6 is a flowchart illustrating an overview of the introduction determination process according to the first embodiment.

FIG. 7 is a flowchart for describing the details of the introduction determination process according to the first embodiment.

FIG. 8 is a flowchart for describing the details of the introduction determination process according to the first embodiment.

FIG. 9 is a flowchart for describing the details of the introduction determination process according to the first embodiment.

FIG. 10 is a flowchart for describing the details of the introduction determination process according to the first embodiment.

FIG. 11 is a flowchart for describing the details of the introduction determination process according to the first embodiment.

FIG. 12 is a flowchart for describing the details of the introduction determination process according to the first embodiment.

FIG. 13 is a specific example of introduction information 134.

FIG. 14 is a diagram illustrating a specific example of the first embodiment.

FIG. 15 is a specific example of the APP introduction information 131.

FIG. 16 is a specific example of the specification information 132.

FIG. 17 is a specific example of the specification information 132 including information about a new application.

FIG. 18 is a diagram illustrating a case where APP-D has been introduced in accordance with the information having an “information ID” of “3” in the introduction information 134 illustrated in FIG. 13.

FIG. 19 is a diagram illustrating a case where the physical machine 2b has stopped.

FIG. 20 is a diagram illustrating a case where the physical machine 2b has stopped.

FIG. 21 is a diagram illustrating a case where the physical machine 2b has stopped.

FIG. 22 is a diagram illustrating the first probability.

FIG. 23 is a diagram illustrating the second probability.

FIG. 24 is a diagram illustrating the third probability.

### DESCRIPTION OF EMBODIMENTS

When constructing a business system, the operator may introduce the application for providing an important service, on a plurality of physical machines (this is also called “application redundancy” below). Therefore, the operator is able to continue the provision of a service to the users, even in cases where a portion of the physical machines on which the application for providing a service to the users has been introduced have stopped.

Here, the operator may, when introducing a new application, determine whether or not to provide redundancy for the new application, so that the operating rate of the new application after introduction satisfies the operating rate demanded (specified) by users on the basis of service usage conditions, etc. However, if the operator is not able to calculate, in advance, the precise operating rate of the new application, then it is not possible to determine whether or not redundancy is to be provided for the new application. Therefore, the operator may have difficulty in deciding upon the method of introduction for the new application. The first embodiment will be explained hereinbelow.

[Configuration of Devices in According to First Embodiment]

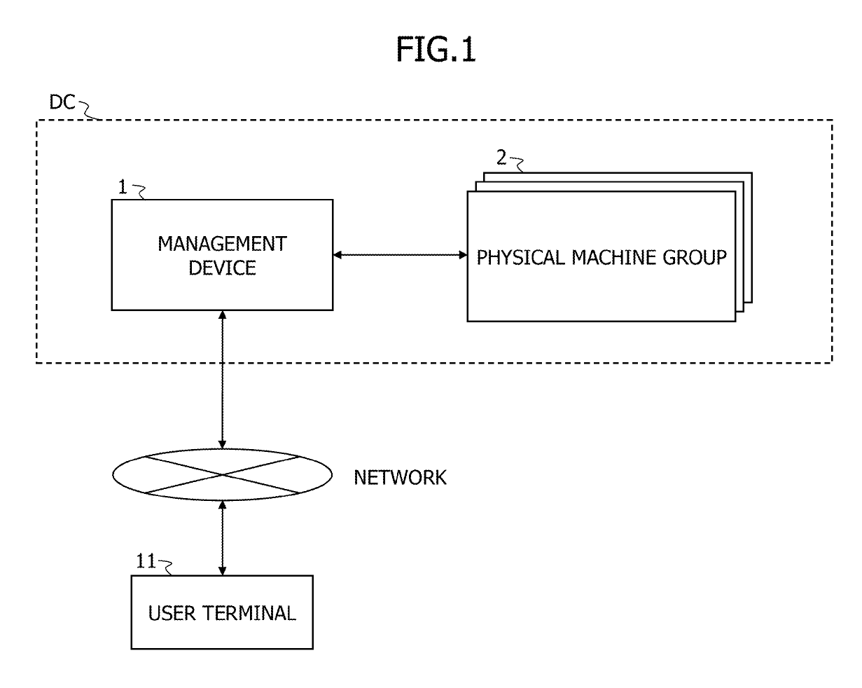

FIG. 1 is a diagram illustrating the devices according to a first embodiment of the present invention. In the example illustrated in FIG. 1, a data center DC is provided with a management device 1 (called “introduction determination device 1” below) and physical machine group 2. Furthermore, the user terminal 11 illustrated in FIG. 1 can, for example, access the data center DC via a network, such as the Internet or an Intranet, etc.

The physical machine group 2 is a group of physical machines configured from one or more physical machine (also called “information processing device” below). A business system for providing a service to users, for example, (also called “information processing system” below) is constructed in the physical machine group 2.

Before a user introduces a new application on the physical machine group 2, the management device 1, for example, calculates the operating rate when the new application is run in a physical machine included in the physical machine group 2. More specifically, the management device 1, for example, calculates the operating rate when a new application specified by a user via the user terminal 11 is run in the physical machine group 2. The management device 1 determines the physical machine in which the new application is to be run, included in the physical machine group 2, in order to satisfy the operating rate of the new application specified by the user via the user terminal 11 (called “specified operating rate” below).

[Specific Example of Introduction of Application to Physical Machines]

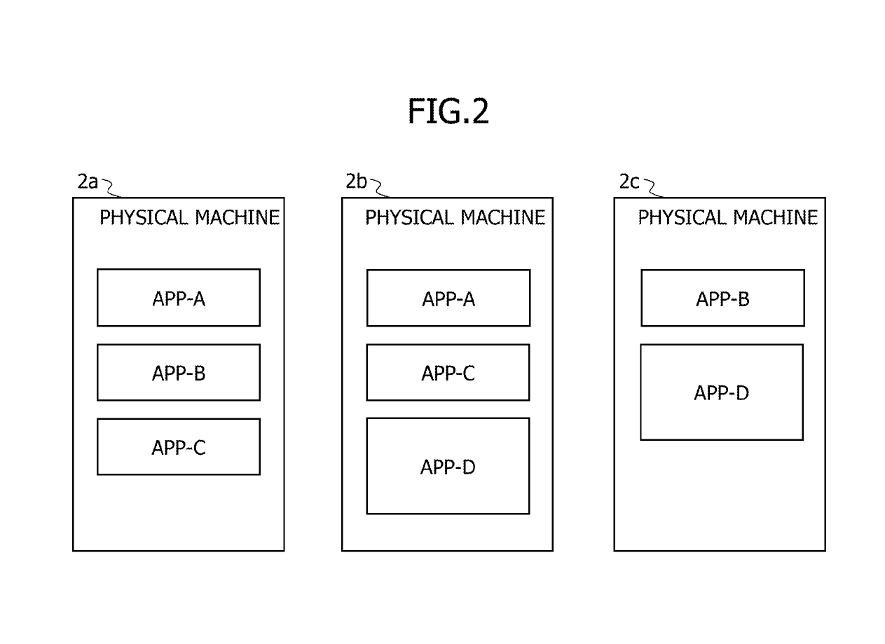

Next, a specific example of the application introduced into the physical machine group 2 will be described. FIG. 2 is a diagram illustrating a specific example of an application introduced into the physical machine group 2. The description given below assumes that the physical machine group 2 includes a physical machine 2a, a physical machine 2b and a physical machine 2c. The description also assumes that the applications introduced into the physical machine group 2 are: application A, application B, application C and application D (respectively called APP-A, APP-B, APP-C, APP-D below).

In the example illustrated in FIG. 2, APP-A, APP-B and APP-C run in the physical machine 2a. Furthermore, in the example illustrated in FIG. 2, APP-A, APP-C and APP-D run in the physical machine 2b. Furthermore, in the examples illustrated in FIG. 2, APP-B and APP-D run in the physical machine 2c. In other words, the respective applications illustrated in FIG. 2 run in two or more physical machines included in the physical machine group 2. Therefore, in the example illustrated in FIG. 2, even if one physical machine of the physical machines in which the applications run is stopped, the operator can continue to provide a service based on the applications.

Therefore, when introducing a new application, the operator may determine whether or not to provide redundancy for the new application, in such a manner that the operating rate of the new application after introduction satisfies the operating rate of the service calculated on the basis of the use conditions of the user, etc. In other words, the operator, when introducing a new application, for example, may receive a specification of the operating rate for the new application (the operating rate of the service based on the application), from the user, instead of determining whether or not to provide redundancy for the new application.

However, when a precise calculation of the operating rate for the new application is not able to be made in advance, the operator is not able to determine whether or not redundancy is to be provided for the new application. Consequently, the operator may have difficulty in determining the method of introduction for the new application.

Therefore, the management device 1 according to the first embodiment receives specification of the application that is to be introduced newly into the business system, and the operating rate for the application to be introduced. The management device 1 determines the possibility of introducing the new application, for each physical machine, on the basis of the contents of the specification thus received, the data volume required for introduction of the new application or processing during operation after introduction of the new application (called the “first amount of information” below), and failure rates and the access performance of the physical machines.

In other words, the management device 1 according to the first embodiment, when calculating the operating rate upon introduction of the new application into the physical machines included into the physical machine group 2, calculates the operating rate by taking account of the access performance of the physical machines, as well as the failure rate of the physical machines. Consequently, the management device 1 is able to calculate the operating rate of the new application by also taking account of the time required to reintroduce the new application as a result of a failure in a physical machine, etc. after the start of operation of the new application.

Accordingly, the management device 1 can determine whether or not it is required to provide redundancy for the new application, for example, on the basis of the operating rate of the new application which is calculated on the basis of the access performance of each of the physical machines, and can provide this determination result to the user. Therefore, the management device 1 is able to provide guidance to the user in determining the method of introduction for the new application, on the basis of the operating rate of the new application calculated on the basis of the access performance of the respective physical machines.

[Hardware Configuration of Information Processing Device]

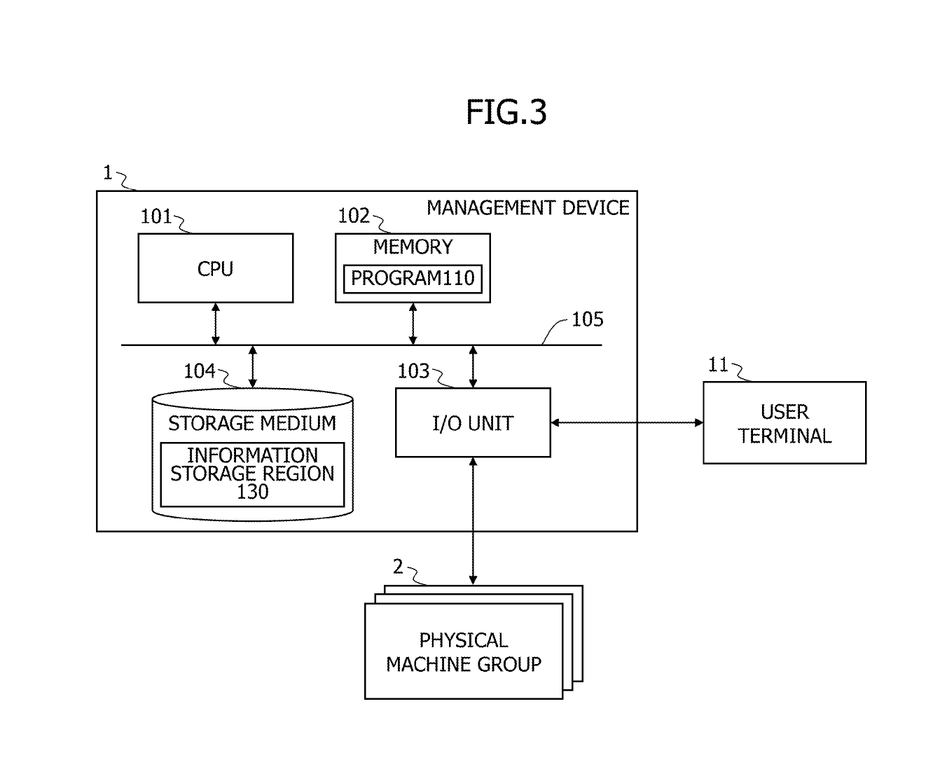

Next, the hardware configuration of the management device 1 is described. FIG. 3 is a diagram illustrating the hardware configuration of the management device 1.

The management device 1 has a central processing unit (CPU) 101, which is a processor, a memory 102, an external interface (I/O unit) 103, and a storage medium (storage) 104. The parts are interconnected via a bus 105.

The storage medium 104 stores a program 110 for carrying out a process (called “introduction determination process” below) to determine whether or not to introduce a new application to each of the physical machines included in the physical machine group 2, in a program storage region (not illustrated) of the storage medium 104. More specifically, the storage medium 104 is, for instance, a hard disk drive (HDD) or a solid state drive (SSD).

As illustrated in FIG. 3, the CPU 101, when executing the program 110, loads the program 110 from the storage medium 104 to the memory 102 and carries out the introduction determination process in coordination with the program 110.

The storage medium 104 has an information storage region 130 which stores information used when carrying out the introduction determination process, for example. Furthermore, the external interface 103 communicates with the physical machine group 2 and the user terminal 11.

[Software Configuration of Information Processing Device]

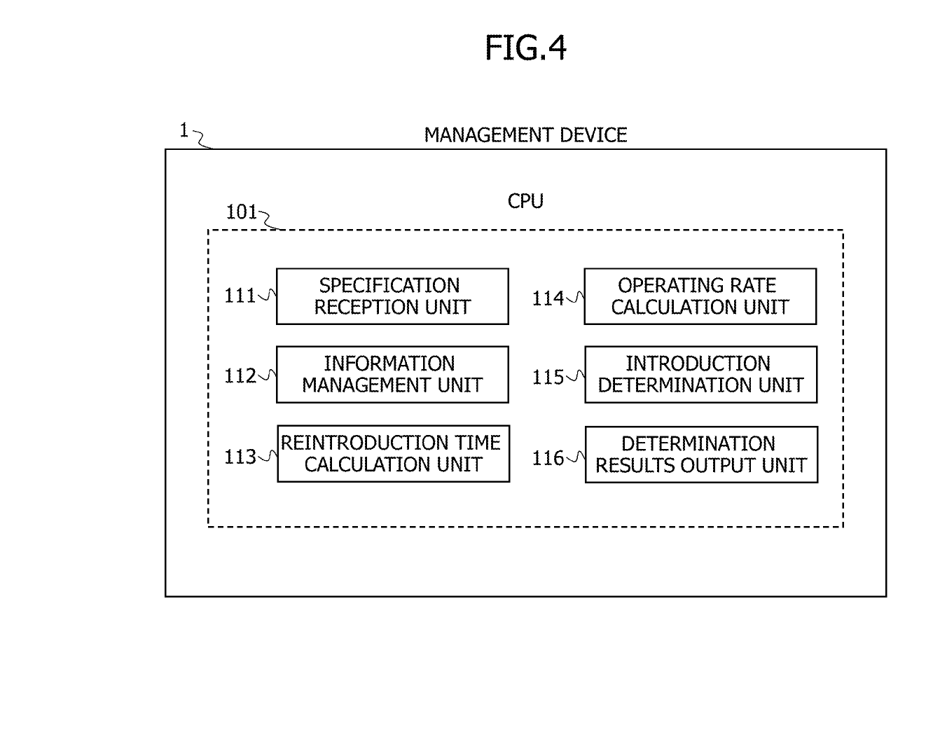

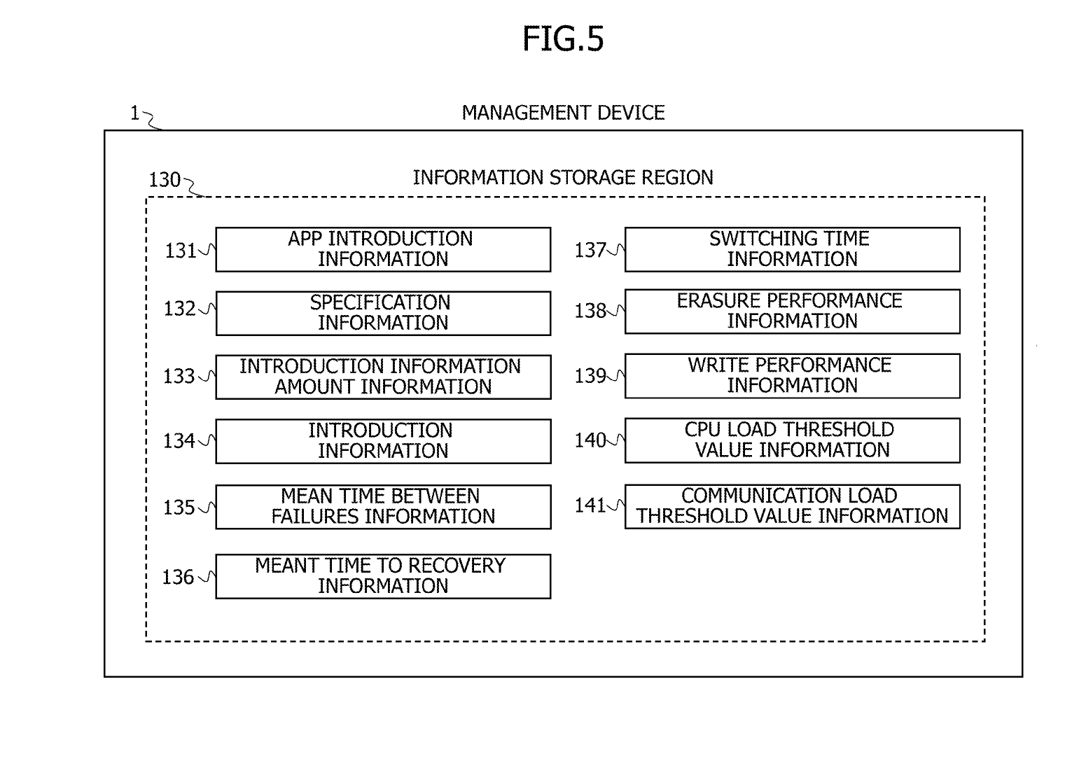

Next, the software configuration of the management device 1 will be described. FIG. 4 is a block diagram of the functions of the management device 1. Furthermore, FIG. 5 is a block diagram of the information stored in the information storage region 130 of the management device 1. As illustrated in FIG. 4, the CPU 101, by coordinated operation with the program 110, operates as a specification reception unit 111, an information management unit 112, a reintroduction time calculation unit 113, an operating rate calculation unit 114, an introduction determination unit 115 and a determination result output unit 116.

Furthermore, as illustrated in FIG. 5, the information storage region 130 stores APP introduction information 131, specification information 132, introduction information amount information 133, introduction candidate information 134 (also called “introduction information 134” below), mean time between failures information 135, and mean time to recovery information 136. Moreover, as illustrated in FIG. 5, the information storage region 130 stores switching time information 137, erasure performance information 138, write performance information 139, CPU load threshold value information 140 (called “first threshold value 140” below), and communication load threshold value information 141 (called “second threshold value 141” below).

The specification reception unit 111 receives specification of the new application that is to be introduced into the physical machine group 2 including the plurality of physical machines, and the operating rate R21 for the new application (specified operating rate R21). More specifically, the specification reception unit 111 receives the contents of the specification input by the user via the user terminal 11, for example. Thereupon, the specification reception unit 111 stores the received specification contents in the information storage region 130 as specification information 132. A specific example of the specification information 132 is described below.

The information management unit 112 creates introduction information 134, which is information relating to one or more introduction method in the case of introducing a new application. More specifically, the information management unit 112, for example, identifies a physical machine having a free capacity of the storage device therein (not illustrated) that is larger than the first information amount, from among the physical machines included in the physical machine group 2.

The first information amount is, for example, the data volume required for introduction of a new application. In other words, the first information amount may be, for example, the data volume that requires to be stored in the storage medium 104 when introducing the new application. The first information amount may also be, for example, the data volume that will require to be stored in the storage medium 104 when a prescribed time has passed after introduction of the new application (predicted data volume).

Moreover, the first information amount may be, for example, the data volume required for processing during operation after introduction of the new application. In other words, the first information amount may be, for example, the data volume expanded into the memory 102 when running the new application.

The information management unit 112 determines one or more introduction method in the case of introducing a new application, for an identified physical machine, for example, and creates introduction information 134, which is information relating to the determined method(s). A specific example of the introduction information 134 is described hereinafter.

The reintroduction time calculation unit 113 selects one introduction method (called “first introduction method” below) from among the one or more introduction methods for which information is included in the introduction information 134. The reintroduction time calculation unit 113 identifies the physical machine to which the new application is to be reintroduced, in a case where the new application has been introduced in accordance with the selected first introduction method and one of the physical machines to which the new application has been introduced fails. The operator may determine a physical machine to which the new application is to be reintroduced in the event of the failure of a physical machine to which the new application has been introduced, and store information about that physical machine in the information storage region 130. The reintroduction time calculation unit 113 may identify the physical machine to which the new application is to be reintroduced, by referring to the information storage region 130.

Thereupon, when the new application is reintroduced, the reintroduction time calculation unit 113 calculates an information erasure time T1 by dividing the amount of information that requires to be erased from the storage device of the physical machine that is carrying out the reintroduction (called “second information amount” below), by the value indicated by the erasure performance information 138.

The erasure performance information 138 is information which indicates the amount of information that can be erased per unit time by the physical machines included in the physical machine group 2, with regard to information that is stored in the storage devices of the physical machines included in the physical machine group 2. Furthermore, the second information amount is, for example, an amount of information equal to or greater than the first amount of information minus the amount of information that can be stored in the free capacity of the storage device of the physical machine to which the new application is to be reintroduced.

In this case, the reintroduction time calculation unit 113 calculates an information write time T2 by dividing the amount of information required to introduce the new application (first information amount), by the value indicated by the write performance information 139.

The write performance information 139 is information indicating the amount of information per unit time that can be written by the physical machines included in the physical machine group 2, to the storage devices of the physical machines included in the physical machine group 2. Below, the information indicating the first information amount is also called introduction information amount information 133. Furthermore, the erasure performance information 138 and write performance information 139 are referred to jointly as access performance information.

Moreover, the reintroduction time calculation unit 113 calculates the reintroduction time T3, which is the time required for reintroduction of the new application, on the basis of the information erasure time T1 and the information write time T2. More specifically, the reintroduction time calculation unit 113 the reintroduction time T3 by, for example, adding together up the information erasure time T1 and the information write time T2. In other words, the reintroduction time calculation unit 113 calculates the reintroduction time T3, which is the time required for reintroduction of the new application to a physical machine to which the new application had not been introduced.

The operator may store the amount of information required to introduce each application introduced in the physical machine group 2, previously, as the introduction information amount information 133, in the information storage region 130. In this case, the reintroduction time calculation unit 113 acquires the first information amount required for introduction of the new application or processing after introduction, by referring to the introduction information amount information 133. In the description given below, it is supposed that the reintroduction of the new application due to, for example, a failure in a physical machine into which the new application has been introduced occurs only once.

The operating rate calculation unit 114 calculates an operating rate R22 for the new application (also called “first operating rate R22” below), on the basis of the failure rates R1 of the physical machines included in the physical machine group 2, and the reintroduction times T3 for the physical machines included in the physical machine group 2.

The failure rate R1 of the physical machines is calculated, for example, on the basis of the mean-time between-failures information 135 which indicates the mean time between failures (MTBF) in the physical machines, and the mean time to recovery information 136 which indicates the mean time to recovery (MTTR) when a physical machine has suffered a failure. More specifically, the failure rate R1 of the physical machines is calculated by dividing the mean time between failures information 135 by the sum of the mean time between failures information 135 and the mean time to recovery information 136.

The introduction determination unit 115 determines whether or not it is possible to introduce a new application in accordance with the first introduction method, on the basis of the first operating rate R22 calculated by the operating rate calculation unit 114. More specifically, the introduction determination unit 115 may determine that the new application can be introduced in accordance with the first introduction method, if the first operating rate R22 calculated by the operating rate calculation unit 114 is equal to or greater than the specified operating rate R21.

Furthermore, for example, the introduction determination unit 115 determines, as a physical machine to which the new application is to be introduced, a physical machine of which the CPU usage rate after introduction of the new application would not exceed the CPU load threshold value information 140, from among the physical machines included in the physical machine group 2. The CPU load threshold value information 140 is information indicating an upper limit threshold value of the CPU usage rate determined for each of the physical machines included in the physical machine group 2.

Moreover, for example, the introduction determination unit 115 determines, as a physical machine to which the new application is to be introduced, a physical machine of which the communication load (communication bandwidth) after introduction of the new application would not exceed the communication load threshold value 141, from along the physical machines included in the physical machine group 2. The communication load threshold value 141 is information indicating an upper limit threshold value of the communication load determined for each of the physical machines included in the physical machine group 2.

The determination result output unit 116 outputs the determination result from the introduction determination unit 115. More specifically, the determination result output unit 116 may output the determination result from the introduction determination unit 115, to the user terminal 11.

The APP introduction information 131 is information relating to the applications that are currently running in the physical machines included in the virtual machine group 2.

Furthermore, the physical machines included in the physical machine group 2 may all be physical machines of the same type (physical machines having the same values for the mean time between failures information 135, etc. between each machine) (below, a physical machine group 2 made up of physical machines of this kind is also called an “appliance product”). In this case, the operator can readily calculate the operating rate of each application.

In other words, if the physical machines included in the physical machine group 2 are physical machines of respectively different types, then the mean time between failures information 135, and the like, differs between each physical machine. In this case, for instance, it is difficult for the operator to gather information relating to all of the physical machines, and therefore difficult to calculate the operating rates of each of the applications that are running as part of a business system. On the other hand, if the business system is constructed on an appliance product as described above, then the mean time between failures information 135 of each physical machine is the same, in principle, for each machine. Consequently, in this case, the operator can easily acquire the information required to calculate the operating rate for each application. Therefore, the operator can easily calculate the operating rate for each application, by constructing a business system using an appliance product.

The description given below assumes that the physical machine group 2 on which the business system has been constructed is an appliance product. In other words, the description given below assumes that the mean time between failures information 135, the mean time to recovery information 136 and the switching time information 137 for each of the physical machines included in the physical machine group 2 are the same respectively, for each machine. Furthermore, the description given below also assumes that the erasure performance information 138, the write performance information 139, the CPU load threshold value information 140 and communication load threshold value 141 for the physical machines included in the physical machine group 2 are the same respectively, for each machine.

[Overview of First Embodiment]

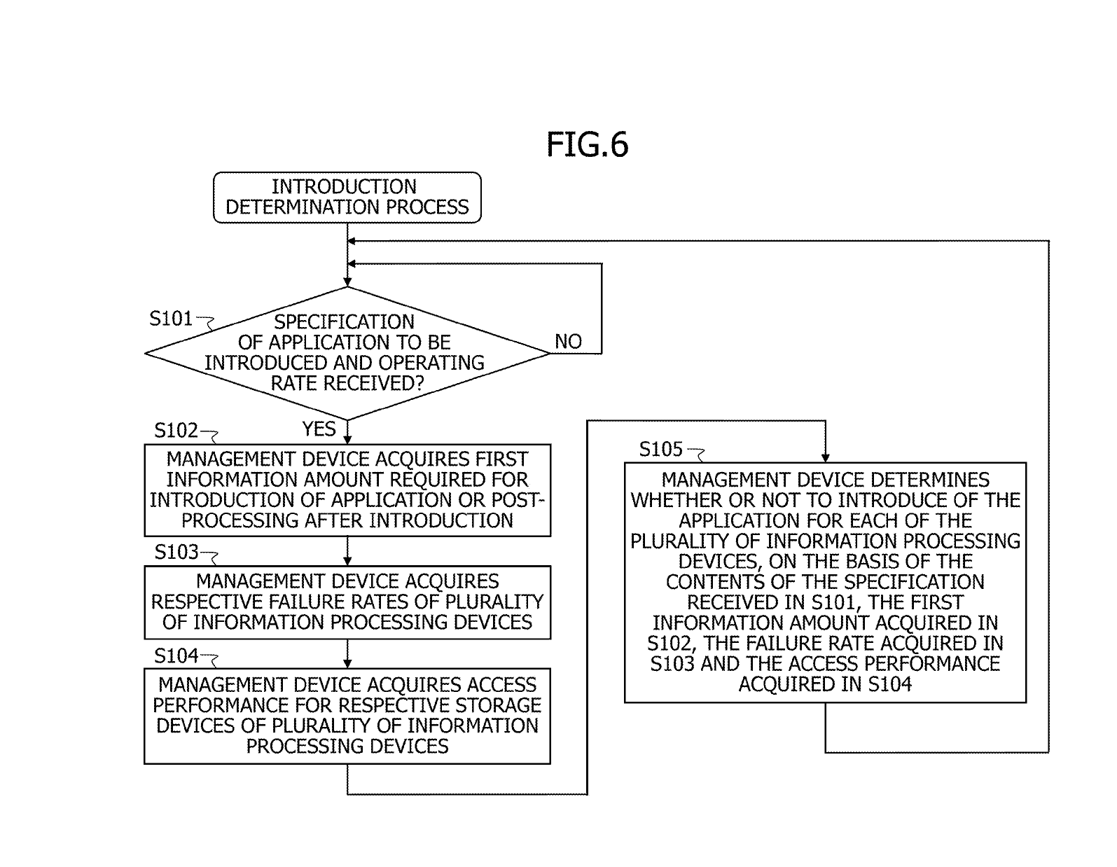

Next, an overview of a first embodiment will be described. FIG. 6 is a flowchart illustrating an overview of the introduction determination process according to the first embodiment.

Firstly, the management device 1 waits until receiving a specification of a new application to be introduced into a physical machine included in the physical machine group 2 and a specification of an operating rate R21 for the new application (NO in S101). More specifically, the management device 1, for example, waits until the contents of the specification are input by a user via the user terminal 11. Upon receiving this specification (YES in S101), the management device 1 acquires the first information amount required for introduction of the new application and a post-processing after introduction (S102). Furthermore, in this case, the management device 1 acquires (calculates) the respective failure rates R1 of the physical machines included in the physical machine group 2 (S103). Moreover, the management device 1 also acquires access performance information for the storage devices of respective physical machines included in the physical machine group 2 (S104).

Thereupon, the management device 1 determines (S105) whether or not introduction of the application is required, for each of the physical machines included in the physical machine group 2, on the basis of the contents of the specification received by the process in S101, and the information acquired by the processes in S102, S103 and S104.

In other words, the management device 1 calculates a first operating rate R22 in the event of introduction of the new application, for each of the physical machines included in the physical machine group 2. More specifically, the management device 1 calculates a first operating rate R22 by taking account of the access performance of each of the physical machines, as well as the failure rate R1 of each physical machine. Therefore, the management device 1 is able, for example, to calculate the first operating rate R22 of the new application by taking account of the time required to reintroduce the new application due to a failure in a physical machine, or the like, after the start of operation of the new application.

Consequently, the management device 1 can determine whether or not it is required to provide redundancy for the new application, on the basis of the operating rate of the new application as calculated on the basis of the access performance of each physical machine, and can present this determination result to the user. Furthermore, the management device 1 can determine to what extent it is required or not required to provide redundancy (multiplexing) for the new application, on the basis of the operating rate of the new application as calculated on the basis of the access performance of each physical machine, and can present this determination result to the user.

In this way, the management device 1 receives the specification of a new application to be introduced in the physical machine group 2 which includes a plurality of physical machines and the first operating rate R21 for the new application. Furthermore, the management device 1 acquires the first information amount required for introduction of the new application and processing after introduction, the respective failure rates R1 of the plurality of physical machines included in the physical machine group 2, and the access performance for the storage devices in each of the physical machines included in the physical machine group 2. The management device 1 then determines whether or not introduction of the new application is required for each of the physical machines included in the physical machine group 2, on the basis of the contents of the received specification and the acquired information.

Consequently, the management device 1 is able to guide the user when determining the introduction method for a new application.

[Details of First Embodiment]

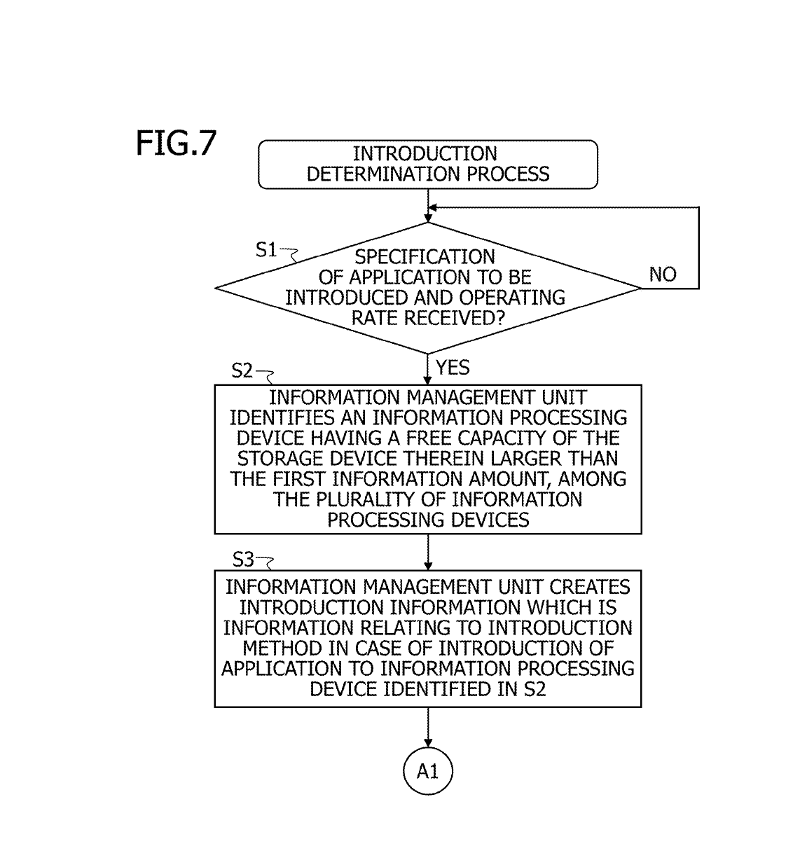

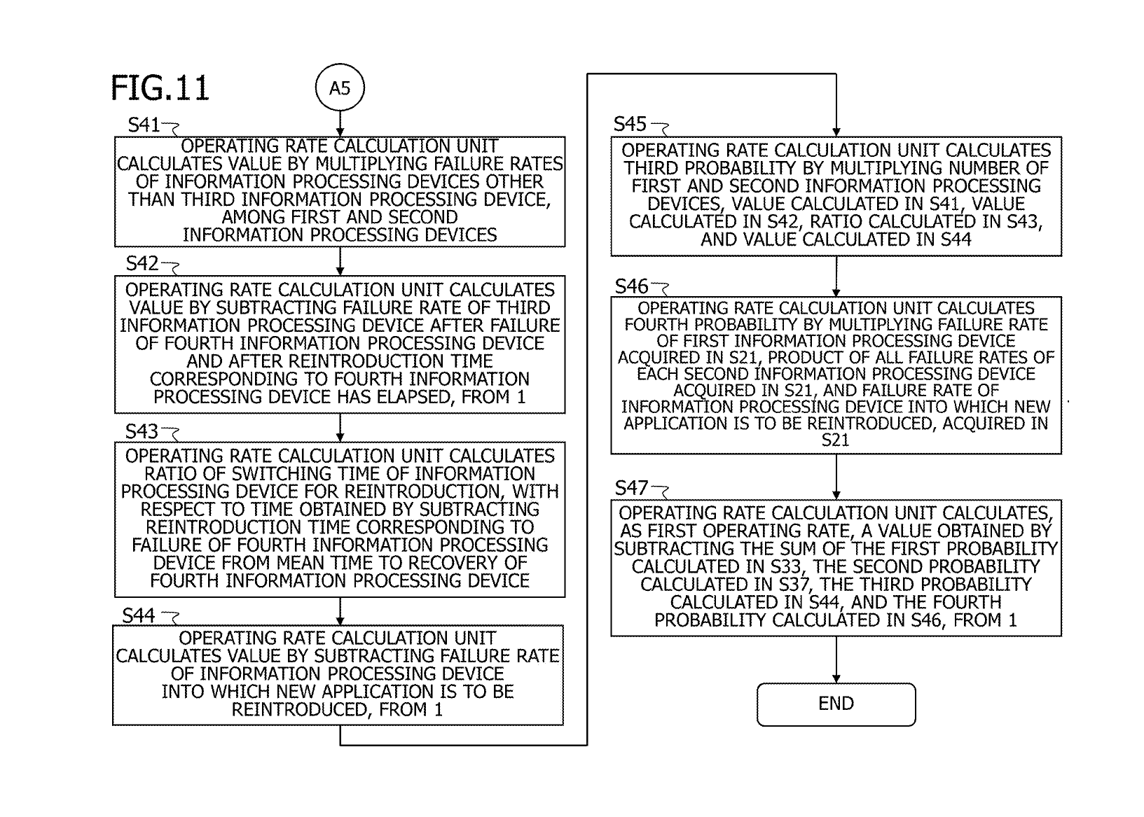

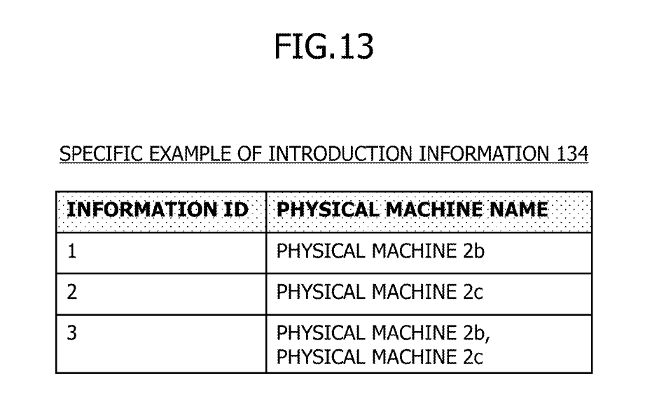

Next, the details of the first embodiment will be described. FIGS. 7 to 12 are flowcharts for describing the details of the introduction determination process according to the first embodiment. Furthermore, FIGS. 13 to 24 are diagrams illustrating the details of the introduction determination process according to the first embodiment. The introduction determination process in FIGS. 7 to 12 is described here with reference to FIGS. 13 to 24. Below, “Gigabyte” is indicated simply as “GB”. Furthermore, “hour” is indicated simply as “h”.

Firstly, the specification reception unit 111 of the management device 1 waits until receiving a specification of a new application to be introducing into a physical machine included in the physical machine group 2 and a specification of the first operating rate R21 for the new application (NO in S1). Thereupon, upon receiving the specification (YES in S1), the information management unit 112 of the management device 1 identifies a physical machine of which the free capacity of the storage device is larger than the first information amount, from among the physical machines included in the physical machine group 2 (S2). More specifically, the information management unit 112 identifies a physical machine into which the new application can be introduced, of the physical machines included in the physical machine group 2.

The information management unit 112 creates introduction information 134, which is information relating to the introduction method in the event of introduction of the new application, for the physical machine identified by the process in S2 (S3). In other words, the information management unit 112 creates introduction information 134 including information for respective introduction patterns of the new application in the physical machine group 2. Thereupon, the information management unit 112 stores the created introduction information 134 in the information storage region 130. A specific example of introduction information 134 is described below.

[Specific Example of Introduction Information]

FIG. 13 is a specific example of introduction information 134. The introduction information 134 depicted in FIG. 13 includes the items: “information ID” which identifies each information element included in the introduction information 134, and “physical machine name” which identifies each physical machine included in the physical machine group 2. The description given below relates to a case where the first information amount of the new application included in the specification received by the specification reception unit 111 is “6000 (GB)”, and the free capacity of the storage devices in the physical machines 2a, 2b and 2c is respectively “2500 (GB)”, “8000 (GB)” and “7000 (GB)”.

In this case, the information management unit 112 identifies the physical machine 2b (which has a free capacity of “8000 (GB)”) and the physical machine 2c (which has a free capacity of “7000 (GB)”) as physical machines into which the new application can be introduced (physical machines having a free capacity greater than “6000 (GB)”). Therefore, the information management unit 112 determines that there exist, as methods for introduction of the new application, a method involving introduction only into the physical machine 2b, a method involving introduction only into the physical machine 2c, and a method involving introduction into the physical machine 2b and the physical machine 2c.

Consequently, the information management unit 112, as depicted in FIG. 13, sets the item “physical machine name” of the information having an “information ID” of “1” to “physical machine 2b”, and sets the item “physical machine name” of the information having an “information ID” of “2” to “physical machine 2c” (S3). Moreover, as depicted in FIG. 13, the information management unit 112 sets the item “physical machine name” of the information having an “information ID” of “3” to “physical machine 2b, physical machine 2c” (S3).

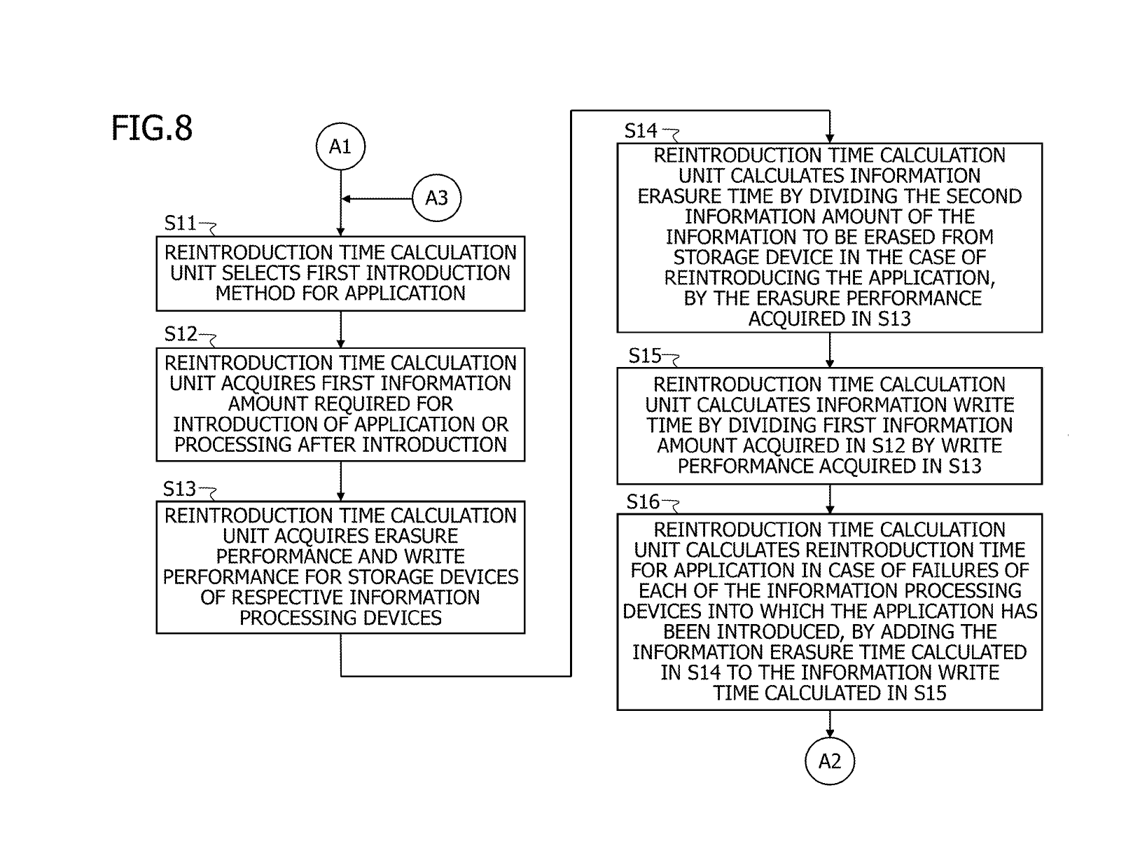

Returning to FIG. 8, the reintroduction time calculation unit 113 of the management device 1 refers to the introduction information 134 stored in the information storage region 130, and selects the first introduction method from the one or more introduction methods for which information is included in the introduction information 134 (S11). The reintroduction time calculation unit 113 then, from the processing in S12 onwards, calculates the reintroduction time T3 in the event of introduction of the new application in accordance with the selected first introduction method.

More specifically, the reintroduction time calculation unit 113 of the management device 1 acquires the first information amount required for introduction of the new application or processing after introduction (S12). The reintroduction time calculation unit 113 may, for example, acquire the first information amount by referring to the introduction information amount information 133 stored in the information storage region. Furthermore, the reintroduction time calculation unit 113 acquires the erasure performance information 138 and write performance information 139 for the storage devices in each of the physical machines included in the physical machine group 2, by referring to the information storage region 130 (S13).

Thereafter, the reintroduction time calculation unit 113 calculates the information erasure time T1 by dividing the amount of information (second information amount) that requires to be erased from the storage device when reintroducing the new application, by the value indicated by the erasure performance information 138 acquired by the process in S13 (S14). If the new application can be reintroduced without erasing information from the storage device, then the reintroduction time calculation unit 113 calculates “0” as the information erasure time T1.

Moreover, the reintroduction time calculation unit 113 calculates the information write time T2 by dividing the first information amount acquired by the process in S12, by the value indicated by the write performance information 139 acquired by the process in S13 (S15).

The reintroduction time calculation unit 113 then calculates the reintroduction time T3 for the new application by adding the information erasure time T1 calculated by the process in S14 to the information write time T2 calculated by the process in S15 (S16). Specific example of calculating the reintroduction time T3 will be described later.

In other words, the reintroduction time calculation unit 113 calculates the reintroduction time T3 for the new application on the basis of the access performance of the physical machine into which the new application is to be reintroduced, of the physical machines included in the physical machine group 2. In this case, the reintroduction time calculation unit 113 also takes account of the time required for erasure from the storage device of the physical machine into which the new application is to be reintroduced. Therefore, as described below, the introduction determination unit 115 of the management device 1 is able to determine more accurately whether or not it is required to introduce the new application, respectively for each of the physical machines included in the physical machine group 2.

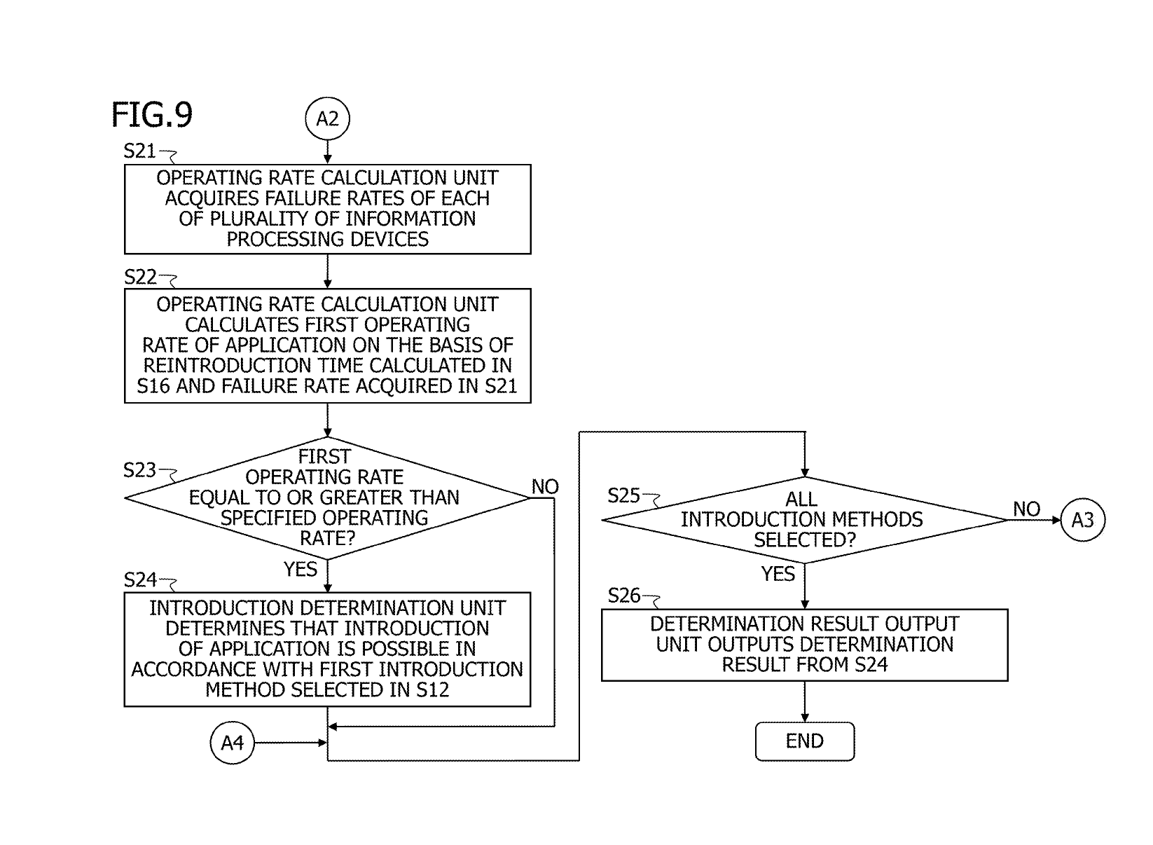

Subsequently, as depicted in FIG. 9, the operating rate calculation unit 114 acquires the failure rate R1 of each physical machine included in the physical machine group 2 (S21). More specifically, the operating rate calculation unit 114 calculates the failure rate R1 for each of the physical machines included in the physical machine group 2, by referring to the mean time between failures information 135 and the mean time to recovery information 136 which is stored in the information storage region 130. The operating rate calculation unit 114 then calculates the first operating rate R22 for the new application, on the basis of the reintroduction time T3 and the failure rate R1 acquired by the process in S21 (S22). The process in S22 is described in detail below.

[Details of Process in S22]

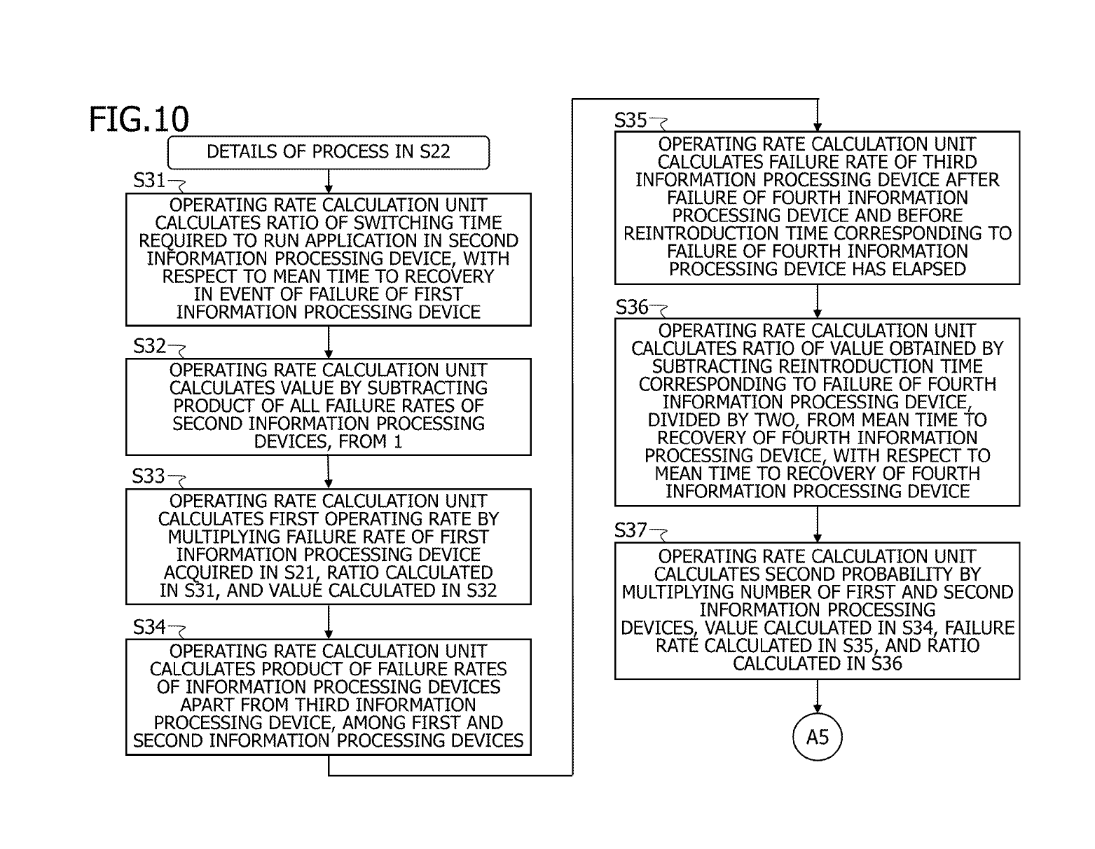

FIG. 10 is a flowchart illustrating the details of the process in S22. More specifically, the operating rate calculation unit 114 calculates the probability of the new application stopping completely, respectively for each cause that might lead to stopping of the new application. The operating rate calculation unit 114 then calculates the operating rate of the new application (the first operating rate R22), by subtracting the respective probabilities thus calculated, from 1.

Below, in a case where the new application has been introduced into physical machines included in the physical machine group 2, the physical machine (one machine) which runs the new application, among the physical machines into which the new application has been introduced, is called the first physical machine or first information processing device. Furthermore, a physical machine (one or more machine) which does not run the new application unless the first physical machine has failed, among the physical machines into which the new application has been introduced, is called a second physical machine or second information processing device.

[Process for Calculating First Probability]

Firstly, the process performed by the operating rate calculation unit 114 in calculating first probability will be described. The first probability is the probability of the new application stopping completely due to a failure in the first physical machine.

The operating rate calculation unit 114 acquires the mean time to recovery information 136 in the event of failure of the first physical machine, by referring to the information storage region 130. Furthermore, the operating rate calculation unit 114 also acquires the switching time information 137 required to run the new application in the second physical machine, by referring to the information storage region 130. The operating rate calculation unit 114 then calculates the ratio of the value indicated by the switching time information 137 for switching to the second physical machine, with respect to the value indicated by the acquired mean time to recovery information 136 of the first physical machine (S31).

Next, the operating rate calculation unit 114 subtracts the value obtained by multiplying together all of the failure rates R1 for each of the second physical machines, from 1 (S32). In other words, the operating rate calculation unit 114 calculates the probability that all of the second physical machines have not failed, in the process in S32.

The operating rate calculation unit 114 then calculates the first probability by multiplying together the failure rate R1 of the first physical machine acquired by the process in S21, the ratio calculated by the process in S31, and the value calculated by the process in S32 (S33).

In other words, when the first physical machine in which the new application is running has failed, the second physical machine starts to run the new application in order to continue the service to the user based on the new application. In this case, the service based on the new application is only stopped for the time required to run the new application in the second physical machine (the switching time information 137).

Therefore, the operating rate calculation unit 114 calculates the probability of the new application stopping completely due to starting the running of the new application on the second physical machine, by multiplying the failure rate R1 of the first physical machine by the ratio calculated by the process in S31. Moreover, the operating rate calculation unit 114 calculates the probability of the new application stopping completely, under conditions in which all of the second physical machines have not failed, by multiplying the value calculated by the process in S32 by the probability of the new application stopping completely.

[Process for Calculating Second Probability]

Next, the process for calculating a second probability performed by the operating rate calculation unit 114 will be described. The second probability is the probability of the new application stopping completely due to failure of all of the physical machines apart from, out of first and second physical machines, one physical machine included in the first and second physical machines (this one physical machine is also called the “third physical machine” or “third information processing device” below), as well as failure of the third physical machine before reintroduction of the new application is completed.

The operating rate calculation unit 114 calculates a value by multiplying together the respective failure rates R1 of the physical machines apart from the third physical machine, among the first and second physical machines (S34). The operating rate calculation unit 114 then calculates the failure rate R1 of the third physical machine, after failure of a fourth physical machine, which is the physical machine to fail first among the first and second physical machines (also called “fourth information processing device” below), and before the reintroduction time T3 corresponding to the failure of the fourth physical machine has elapsed (S35). The reintroduction time T3 corresponding to the failure of the fourth physical machine means the time required to reintroduce the new application into a physical machine where the new application has not been introduced, due to the failure of the fourth physical machine.

Moreover, the operating rate calculation unit 114 calculates the ratio of the value obtained by dividing the reintroduction time T3 corresponding to the failure of the fourth physical machine by two and subtracting this value from the value indicated by the mean time to recovery information 136 of the fourth physical machine, with respect to the value indicated by the mean time to recovery information 136 of the fourth physical machine (S36).

Thereupon, the operating rate calculation unit 114 calculates the second probability by multiplying the number of first and second information processing devices, the value calculated by the process in S34, the failure rate R1 calculated by the process in S35, and the ratio calculated by the process in S36 (S37).

In other words, when any one of the physical machines among the first and second physical machines fails, the operator reintroduces the new application into a physical machine where the new application has not been introduced, in order to restore the redundancy of the new application. Here, if all of the first and second physical machines fail before the reintroduction of the new application has been completed, then it becomes impossible to transfer required information from the first physical machine. Therefore, in this case, the operator is not able to reintroduce the new application. Consequently, the provision of the service based on the new application is stopped before the fourth physical machine, which is the first physical machine to have failed, is recovered.

Therefore, the operating rate calculation unit 114 calculates the probability of failure of all of the physical machines apart from the third physical machine, among the first and second physical machines, by multiplying the number of first and second physical machines by the value calculated by the process in S34. The operating rate calculation unit 114 then multiplies this probability of failure of all of the first and second physical machines apart from the third physical machine, by the probability of the third physical machine failing before the redundancy for the new application is restored and thereby calculates the probability of failure of all of the first and second physical machines before redundancy is restored. Moreover, the operating rate calculation unit 114 also calculates the probability of the service based on the new application being stopped in the event of failure of all of the first and second physical machines before the restoration of redundancy, by multiplying by the ratio calculated by the process in S36.

In the event of failure of all of the first and second physical machines before restoration of redundancy, the service based on the new application does not stop after the failure of the fourth physical machine, until the third physical machine fails. Therefore, the operating rate calculation unit 114 requires to calculate the first operating rate R22 assuming that the service based on the new application has been provided during this period. The mean time from the failure of the fourth physical machine to the failure of the third physical machine is obtained by dividing the introduction time of the third physical machine by two. Therefore, in the event of failure of all of the first and second physical machines before the restoration of redundancy, the average of the time during which the service based on the new application is stopped will be the mean time to recovery information 136 of the fourth physical machine minus half the introduction time of the third physical machine. Consequently, the operating rate calculation unit 114, in the process in S36, calculates the ratio of the value obtained by subtracting the introduction time of the third physical machine divided by two, from the mean time to recovery information 136 of the fourth physical machine, with respect to the mean time to recovery information 136 of the fourth physical machine. The operating rate calculation unit 114 then calculates the first operating rate R22 by taking account of the value thus calculated. Accordingly, the operating rate calculation unit 114 is able to calculate the first operating rate R22 more precisely.

[Process for Calculating Third Probability]

Next, the process for calculating a third probability performed by the operating rate calculation unit 114 will be described. The third probability is the probability of the new application stopping completely due to failure of all of the physical machines apart from the third physical machine, among the first and second physical machines, followed by failure of the third physical machine after reintroduction of the new application, and running of the new application that has been reintroduced.

The operating rate calculation unit 114 calculates a value by multiplying together the respective failure rates R1 of the physical machines apart from the third physical machine, among the first and second physical machines (S41). Furthermore, the operating rate calculation unit 114 calculates a value by subtracting the failure rate R1 of the third physical machine after the reintroduction time T3 of the third physical machine has passed and after failure of the fourth physical machine, from 1 (S42). Moreover, the operating rate calculation unit 114 calculates the ratio of the switching time information 137 of the physical machine into which the new application is reintroduced, with respect to the time obtained by subtracting the reintroduction time T3 corresponding to the failure of the fourth physical machine, from the mean time to recovery information 136 of the fourth physical machine (S43). The operating rate calculation unit 114 then calculates a value by subtracting the failure rate R1 of the physical machine into which the new application is reintroduced, from 1 (S44).

Subsequently, the operating rate calculation unit 114 calculates the third probability by multiplying the number of first and second physical machines, the value calculated by the process in S41, the value calculated by the process in S42, the ratio calculated by the process in S43, and the value calculated by the process in S44 (S45).

In other words, the third probability is the probability of failure of all of the first and second physical machines after the restoration of redundancy for the new application, whereas the second probability is the probability of failure of all of the first and second physical machines before the restoration of redundancy. Therefore, in this case, the new application has already been reintroduced. Consequently, the management device 1 can provide a service based on the new application, by running the new application that has been reintroduced. The service based on the new application stops temporarily while the reintroduced new application is being made to run, similarly to the case of the first probability.

Therefore, the operating rate calculation unit 114 calculates the probability of failure of all of the physical machines apart from the third physical machine, among the first and second physical machines, by multiplying the number of first and second physical machines by the value calculated by the process in S41. The operating rate calculation unit 114 then calculates the probability of failure of all of the first and second physical machines after restoration of redundancy, by multiplying the probability of failure of all of the first and second physical machines apart from the third physical machine, by the probability of failure of the third physical machine after restoration of redundancy for the new application. Moreover, the operating rate calculation unit 114 also calculates the probability of the service based on the new application stopping in the event of failure of all of the first and second physical machines after restoration of redundancy, by multiplying the ratio calculated by the process in S43 by the value calculated by the process in S44.

[Process for Calculating Fourth Probability]

Next, the process for calculating a fourth probability performed by the operating rate calculation unit 114 will be described. The fourth probability is the probability of failure of all of the first, second and third physical machines.

The operating rate calculation unit 114 calculates the fourth probability by multiplying the failure rate R1 of the first physical machine acquired by the process in S21, the product of the respective failure rates R1 of the second physical machines acquired by the process in S21, and the failure rate R1 of the information processing device to which the new application is reintroduced, acquired by the process in S21 (S46).

In other words, when restoration of the redundancy of the new application has been carried out once only, and all of the first, second and third physical machines have failed, then the service based on the new application is stopped.

[Process for Calculating First Operating Rate]

Thereupon, the operating rate calculation unit 114 calculates a first operating rate R22 by subtracting the sum of the first probability calculated by the process in S33, the second probability calculated by the process in S37, the third probability calculated by the process in S45 and the fourth probability calculated by the process in S46, from 1 (S47). In other words, the operating rate calculation unit 114 subtracts the probabilities corresponding to respective cases in which the service based on the new application is stopped (the first probability, the second probability, the third probability and the fourth probability), from 1. Accordingly, the introduction determination unit 115 is able to calculate the first operating rate R22 of the service based on the new application.

Returning to FIG. 9, the introduction determination unit 115 determines whether or not the first operating rate R22 calculated by the process in S22 is equal to or greater than the specified operating rate R21 which has been specified in the process in S1 (S23). If the first operating rate R22 is equal to or greater than the specified operating rate R21 (YES in S23), then the introduction determination unit 115 determines that introduction of the new application is possible in accordance with the first introduction method that was selected by the process in S12 (S24).

[Details of Process in S24]

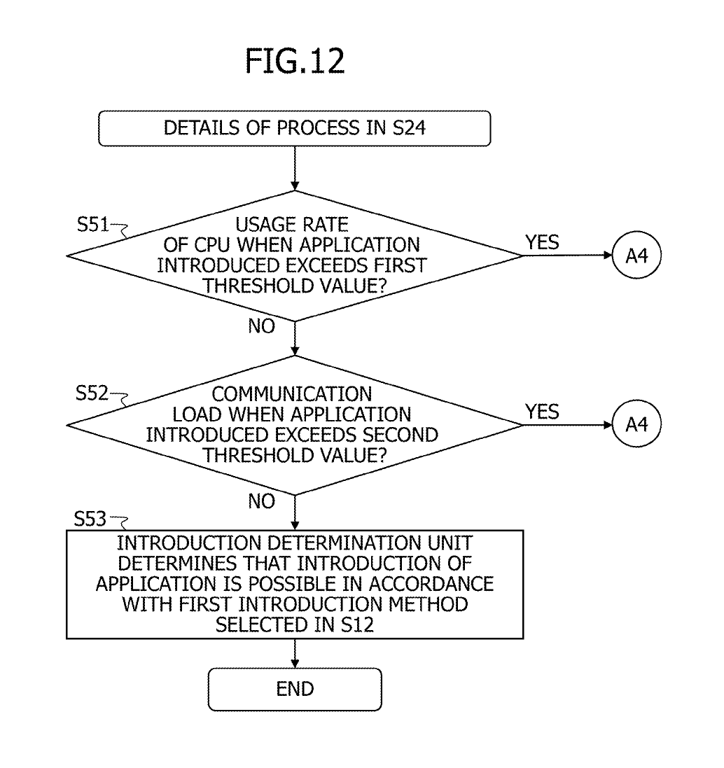

Next, the details of the process in S24 will be described. FIG. 12 is a flowchart illustrating the details of the process in S24.

As illustrated in FIG. 12, the introduction determination unit 115 determines whether or not there is a physical machine of which the CPU usage rate would exceed the CPU load threshold value information 140 in the event of the new application being introduced into that physical machine in accordance with the first introduction method (S51). Furthermore, the introduction determination unit 115 determines whether or not there is a physical machine in which the communication load would exceed the communication load threshold value 141 in the event of the new application being introduced into that physical machine by the first introduction method (S52). If there is no physical machine that would exceed the CPU load threshold value information 140 and no physical machine that would exceed the communication load threshold value 141 (NO in S51, NO in S52), then the introduction determination unit 115 determines that it is possible to introduce the new application in accordance with the first introduction method (S53).

Returning to FIG. 9, if the first operating rate R22 is not equal to or greater than the specified operating rate R21 (NO in S23), then the introduction determination unit 115 does not execute the process in S24. Similarly, if there is a physical machine that would exceed the CPU load threshold value information 140 or a physical machine that would exceed the communication load threshold value 141 (YES in S51, YES in S52), then the introduction determination unit 115 does not execute the process in S24. In other words, in these cases, the introduction determination unit 115 determines that it is not possible to introduce the new application in accordance with the first introduction method.

Consequently, the introduction determination unit 115 is able to exclude an introduction method which would cause the CPU usage rate and/or the communication load to exceed the predetermined threshold values, even if the first operating rate R21 is equal to or greater than the specified operating rate R22 when the new application is introduced in accordance with the first introduction method. Therefore, the introduction determination unit 115 is able to make a determination for more stable running of the new application in the business system after introduction of the new application.

Subsequently, in the process in S11, the introduction determination unit 115 determines whether or not all of the introduction methods included in the introduction information 134 have been selected (S25). If all of the introduction methods have been selected (YES in S25), then the determination result output unit 116 of the management device 1 outputs the determination result of the process in S24 (S26).

Consequently, the user can acquire information about the state of operation of the business system in the event of introduction of the specified application into the physical machine group 2. Therefore, the user can determine whether or not the new application is to be introduced on the basis of the acquired information. Furthermore, the user can determine the specific introduction method for the new application in the physical machine group 2, on the basis of the acquired information.

[Specific Example of First Embodiment]

Next, a specific example of the first embodiment will be described. Below, similarly to FIG. 2, it is assumed that the physical machine group 2 includes a physical machine 2a, a physical machine 2b and a physical machine 2c.

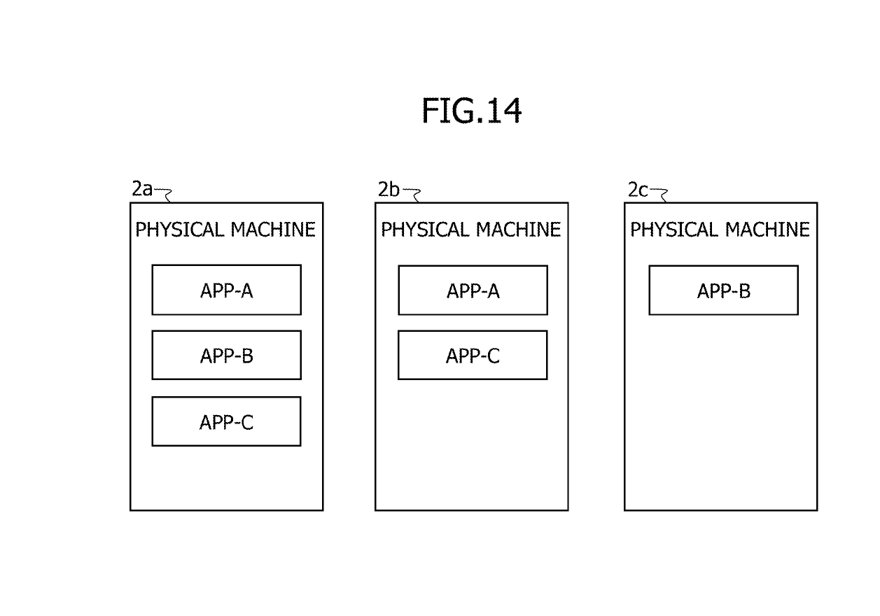

FIG. 14 is a diagram illustrating a specific example of the first embodiment. In the example illustrated in FIG. 14, APP-A, APP-B and APP-C are running in the physical machine 2a. Furthermore, APP-A and APP-C are running in the physical machine 2b, and APP-B is running in the physical machine 2c. There follows a description of a specific example of the APP introduction information 131 and the specification information 132 corresponding to the state of introduction of the applications illustrated in FIG. 14.

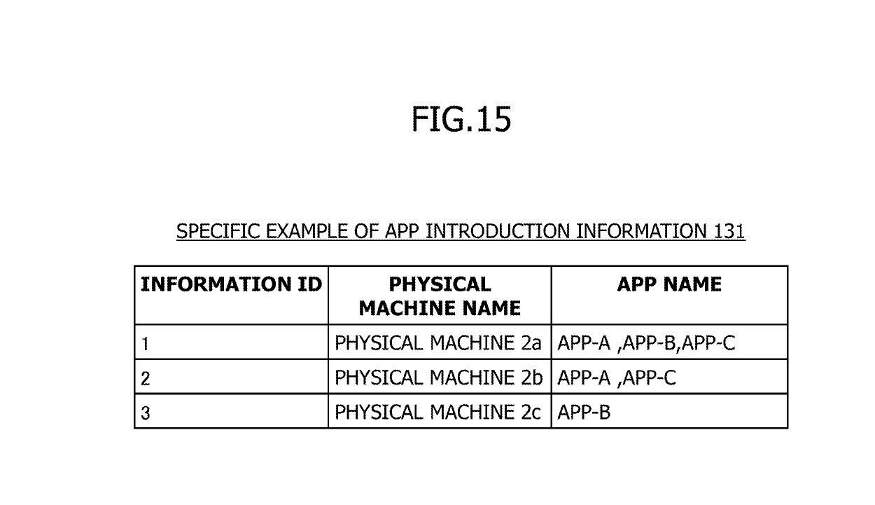

FIG. 15 is a specific example of the APP introduction information 131. The APP introduction information 131 illustrated in FIG. 15 includes the items: “information ID” which identifies each information element included in the APP introduction information 131; “physical machine name” which identifies each physical machine included in the physical machine group 2; and “APP (application) name” which identifies the application running in each physical machine.

More specifically, in the APP introduction information 131 illustrated in FIG. 15, in the information having an “information ID” of “1”, the “physical machine name” is set to “the physical machine 2a”, and the “APP name” is set to “APP-A, APP-B, APP-C”. The other information in FIG. 15 is not described here.

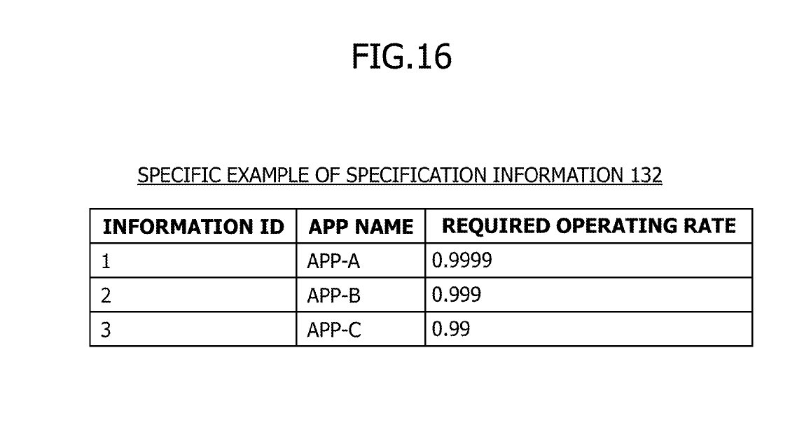

Furthermore, FIG. 16 is a specific example of the specification information 132. The specification information 132 illustrated in FIG. 16 includes the items: “information ID” which identifies each information element included in the specification information 132; “APP name” which identifies the application running in each physical machine; and “required operating rate” which is the operating rate required for each application. More specifically, in the specification information 132 illustrated in FIG. 16, in the information having an “information ID” of “1”, the “APP name” is set to “APP-A”, and the “required operating rate” is set to “0.9999”. In other words, the applications illustrated in FIG. 14 are introduced into the physical machines in such a manner that the first operating rate R22 of each application exceeds the operating rate (specified operating rate R21) set in the “required operating rate” of the specification information 132 illustrated in FIG. 16.

Here, in the example illustrated in FIG. 14, when introducing a new application, the user inputs the specification information 132 including information about the new application, to the management device 1. More specifically, the user, for example, sends specification information 132 including information about the new application, to the management device 1, via the user terminal 11. The description given below relates to a specific example of specification information 132 which is sent by the user when introducing a new application. In the following description, the new application is taken to be APP-D.

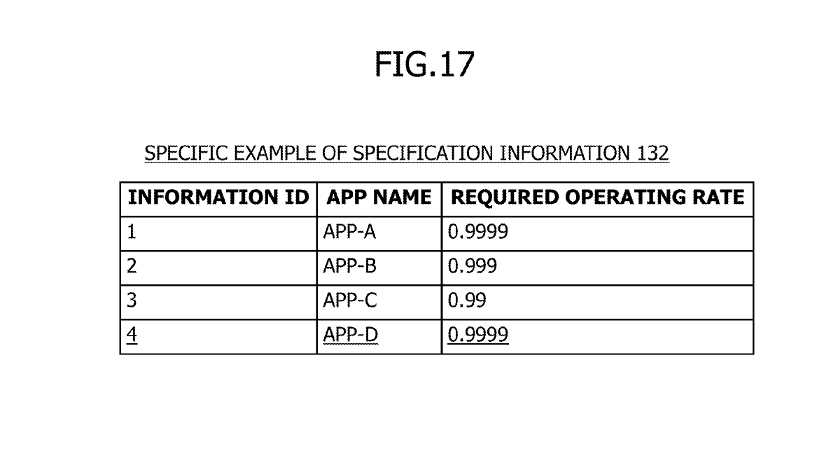

FIG. 17 is a specific example of the specification information 132 including information about a new application. The specification information 132 illustrated in FIG. 17, in comparison with the specification information 132 illustrated in FIG. 16, also includes an information element (“information ID”=“4”) in which the “APP name” is set to “APP-D” and the “required operating rate” is “0.9999” (see the underlined portion of FIG. 17).

When the specification reception unit 111 has received the specification information 132 illustrated in FIG. 17 (YES in S1), the information management unit 112, for example, creates the introduction information 134 illustrated in FIG. 13 (S3). Thereupon, the reintroduction time calculation unit 113, for example, selects information contained in the introduction information 134 illustrated in FIG. 13 (S11). The description below assumes that, in the process in S11, the information having an “information ID” of “3” is selected, from the introduction information 134 illustrated in FIG. 13.

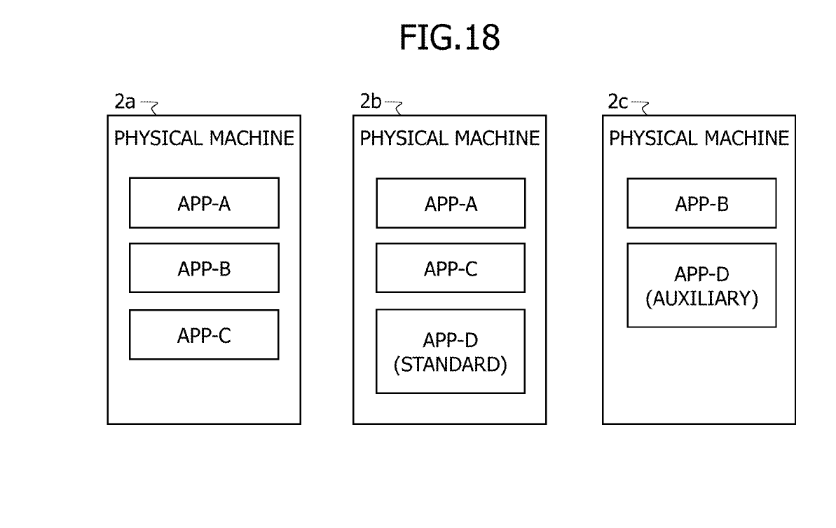

FIG. 18 is a diagram illustrating a case where APP-D has been introduced in accordance with the information having an “information ID” of “3” in the introduction information 134 illustrated in FIG. 13. More specifically, in the example illustrated in FIG. 18, APP-D is introduced into the physical machine 2b and the physical machine 2c. Below, it is assumed that the APP-D introduced into the physical machine 2b is a main APP-D (an APP-D which runs normally). Furthermore, below, it is assumed that the APP-D introduced into the physical machine 2c is an auxiliary APP-D (an APP-D which runs only when the main APP-D has stopped).

The reintroduction time calculation unit 113 then calculates the reintroduction time T3 for APP-D in the event of stopping of one of the physical machines into which APP-D has been introduced (S12 to S16). There follows a description of a specific example of the operation of each physical machine in the event of stopping of one of the physical machines into which APP-D has been introduced.

[Specific Example of Operation in the Event of Stopping of a Physical Machine into which APP-D has been Introduced]

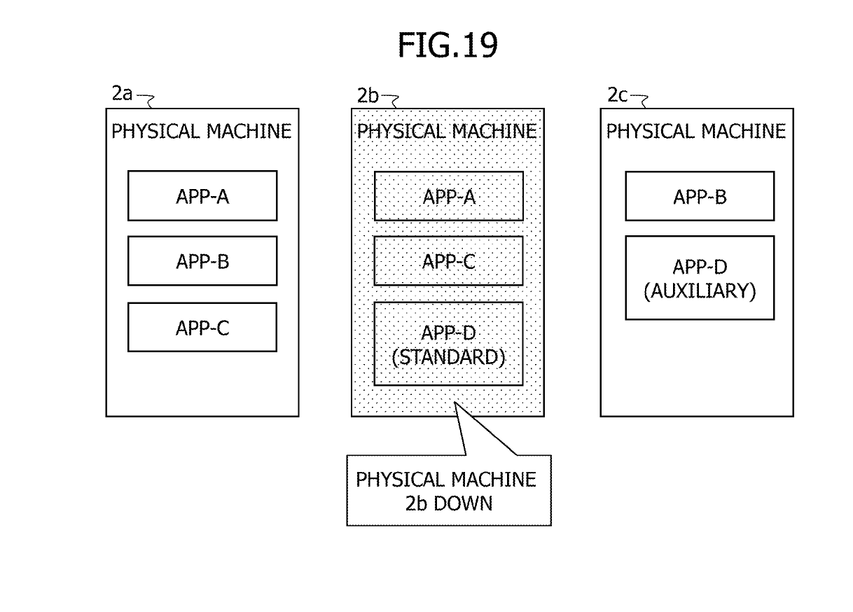

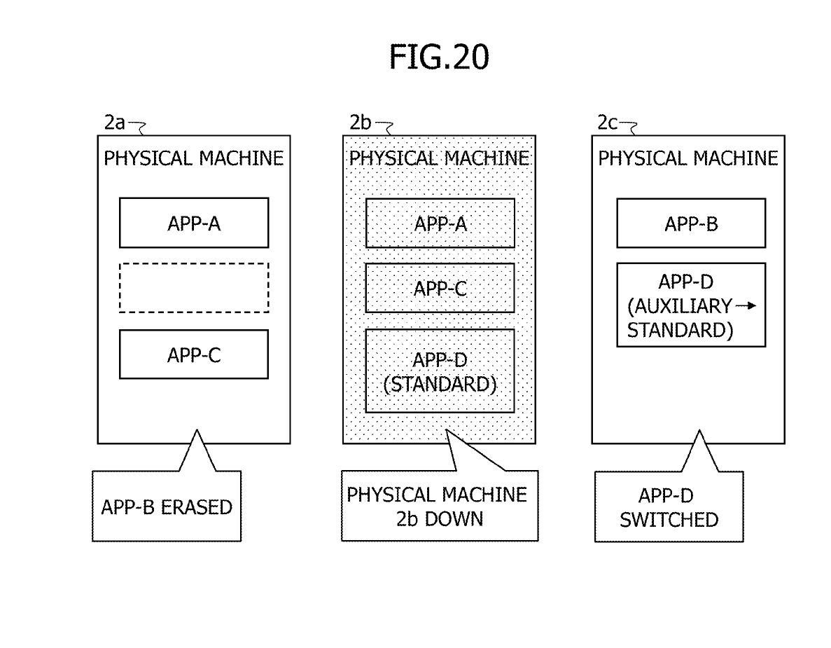

FIGS. 19 to 21 are diagrams illustrating a case where the physical machine 2b has stopped. As illustrated in FIG. 19, when the physical machine 2b has stopped (is down), the operator causes the auxiliary APP-D introduced on the physical machine 2c to run, as illustrated in FIG. 20. Therefore, the operator is able to continue provision of the service based on APP-D.

On the other hand, as illustrated in FIG. 19, when the physical machine 2b has stopped, the redundancy for APP-A, APP-C and APP-D which had been introduced into the physical machine 2b is lost. Therefore, the first operating rates R22 of APP-A, APP-C and APP-D may be respectively lower than the specified operating rates R21 for APP-A, APP-C and APP-D contained in the specification information 132 in FIG. 17. Accordingly, in this case, the operator restores the redundancy by reintroducing at least the applications of which the first operating rate R22 is lower than the specified operating rate R21, into a physical machine where those applications had not been introduced. The description given below assumes that only the application APP-D is reintroduced due to the stopping of the physical machine 2b. Furthermore, in the example illustrated in FIG. 19, the only physical machine into which the APP-D had not been introduced is the physical machine 2a. Therefore, it is assumed that the operator carries out reintroduction of APP-D into the physical machine 2a.

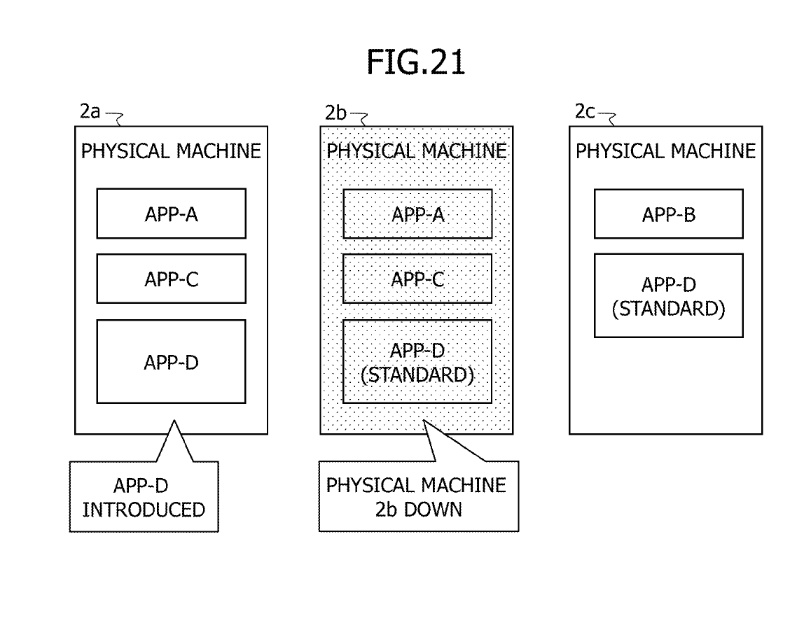

Moreover, if the first information amount required in order to reintroduce APP-D exceeds the free capacity of the physical machine 2a, then as illustrated in FIG. 20, the operator is required to erase an application that has been introduced into the physical machine 2a, before reintroducing APP-D into the physical machine 2a. More specifically, as illustrated in FIG. 20, the operator erases APP-B, for example, which is an application introduced into physical machine 2a. After APP-B has been erased from the physical machine 2a, the operator then reintroduces APP-D into the physical machine 2a, as illustrated in FIG. 21. Thereby, the operator is able to restore the redundancy for APP-D. The description given below relates to a specific example of a case where the reintroduction time T3 is calculated in the case illustrated in FIGS. 19 to 21.

[Specific Example of Calculating Reintroduction Time T3]

In the example illustrated in FIGS. 19 to 21, if the amount of information of the erased APP-B is “12000 (GB)” and the value of the erasure performance information 138 is “1000 (GB/h)”, then the reintroduction time calculation unit 113 divides “12000 (GB)” by “1000 (GB/h)”. As a result, the reintroduction time calculation unit 113 calculates that the information erasure time T1 is “12 (h)” (S14).

Furthermore, if the information amount of APP-D (first information amount) is “6000 (GB)” and the value of the write performance information 139 is “500 (GB/h)”, then the reintroduction time calculation unit 113 divides “6000 (GB)” by “500 (GB/h)”. Consequently, the reintroduction time calculation unit 113 calculates the information write time T2 to be “12 (h)” (S15).

The reintroduction time calculation unit 113 then calculates the reintroduction time T3 to be “24 (h)”, by adding the calculated information erasure time T1 of “12 (h)” to the calculated information write time T2 of “12 (h)” (S16).

If the first information amount of APP-D exceeds the free capacity of the physical machine 2a, then the operator may erase an application of which the first operating rate R22 would not become lower than the specified operating rate R21, even with erasure from the physical machine 2a, from among the applications in the physical machine 2a. Consequently, the operator can restore redundancy for APP-D without affecting the services based on other applications.

Furthermore, if there is no application of which the first operating rate R22 would not become lower than the specified operating rate R21 even with erasure of the application, then the operator may, for example, restore redundancy for APP-D by erasing an application having a lower priority than APP-D.

[Specific Example of Calculating First Operating Rate R22]

The operating rate calculation unit 114 calculates the first operating rate R22 of APP-D on the basis of the reintroduction time T3 calculated by the process in S16 and the failure rates R1 of each physical machine acquired by the process in S21 (S22). In the description below, it is assumed that the value of the mean time between failures information 135 is “8760 (h)” and the value of the mean time to recovery information 136 is “168 (h)”. In other words, the failure rate R1 is “0.018817 (to 6 decimal places)”, as obtained by dividing “8760 (h)” by the sum of “8760 (h)” and “168 (f)”, to give “0.981183” (to 6 decimal places)”, and then subtracting from 1. Furthermore, the value of the switching time information 137 is taken to be “0.01 (h)”.

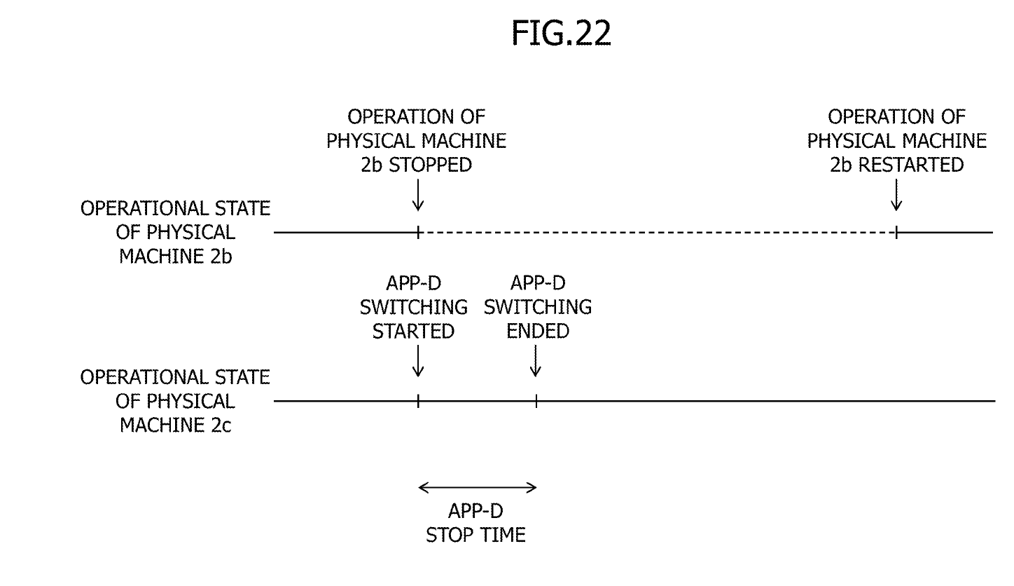

Firstly, the operating rate calculation unit 114 calculates the first probability (S31 to S33). FIG. 22 is a diagram illustrating the first probability. The operating rate calculation unit 114 calculates the first probability as the probability of APP-D stopping due to the physical machine 2b stopping and APP-D starting to run (switching of APP-D) on the physical machine 2c, as indicated by “APP-D stop time” in FIG. 22. More specifically, the first probability is calculated by formula 1 below, for example.

first probability=failure rate R1×(1−a value obtained by raising failure rate R1 to the power of an exponent, subtracted by 1 from the number of physical machines, into which the new application has been introduced)×(value of switching time information 137/value of mean time to recovery information 136) (Formula 1)

In the example illustrated in FIG. 18, the physical machines into which APP-D have been introduced are the physical machine 2b and the physical machine 2c, and the number of physical machines into which APP-D has been introduced is two. Therefore, the value obtained by subtracting one from the number of physical machines into which APP-D has been introduced is “1”. Consequently, from Formula 1 stated above, the first probability is the value of “0.000001 (to six decimal places)”, as calculated by “0.018817×(1−(0.018817)¹)×(0.01/168)”. The contents of Formula 1 correspond to the contents described in relation to the process in S31 to S33.

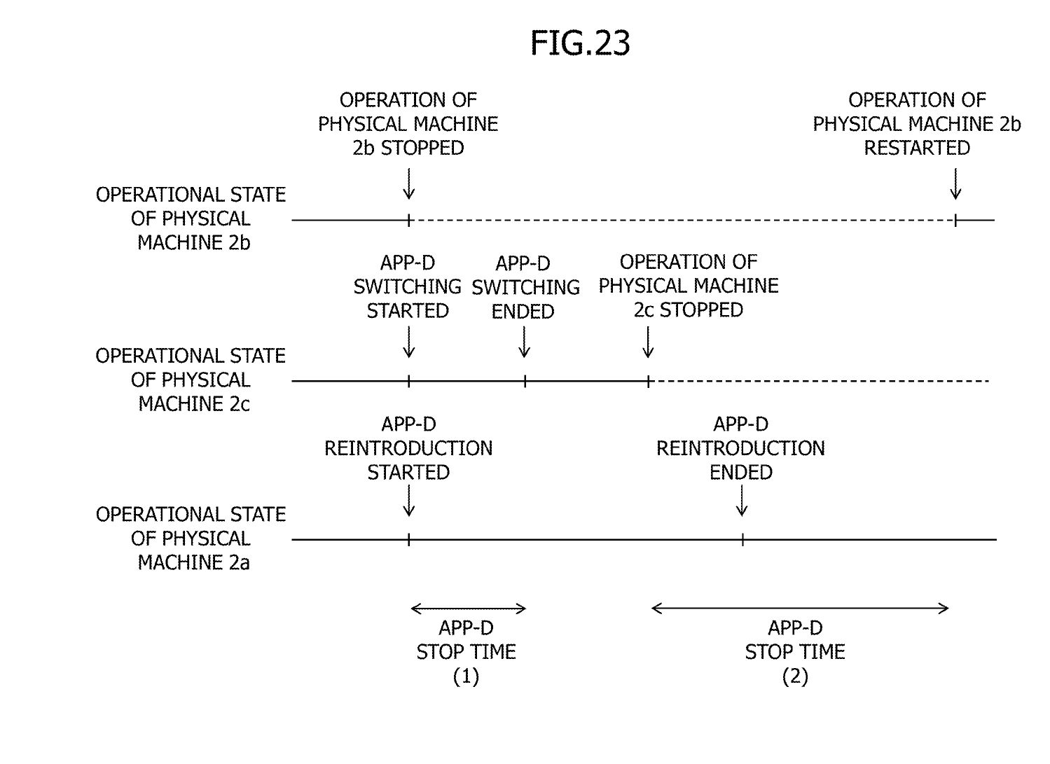

Next, the operating rate calculation unit 114 calculates the second probability (S34 to S37). FIG. 23 is a diagram illustrating the second probability. The operating rate calculation unit 114 calculates the second probability which is the probability of APP-D stopping due to stopping of the physical machine 2c (the last physical machine capable of running APP-D) before reintroduction to the physical machine 2a has been completed, as indicated by “APP-D stop time (2)” in FIG. 23. The “APP-D stop time (1)” in FIG. 23 is the same as the contents described in relation to “APP-D stop time” in FIG. 22, and therefore further description thereof is omitted here.

Furthermore, the probability of failure of the physical machine 2c (called P below), after failure of the physical machine 2b and before reintroduction of APP-D into the physical machine 2a has been completed, is calculated by the known formula indicated below.

P=1−cumulative value of e (Napier's constant) to the power of an exponent (reintroduction time T3/mean time between failures information 135, minus 1) (Formula 2)

The second probability is then calculated by formula 3 below, using Formula 2.

second probability=number of physical machines into which the new application has been introduced×a value obtained by raising failure rate R1 to the power of an exponent, subtracted by 1 from the number of physical machines, into which the new application has been introduced×P×(mean time to recovery information 136−reintroduction time T3 divided by 2)/mean time to recovery information 136 (Formula 3)

Therefore, in the example illustrated in FIG. 18, from Formulas 2 and 3 given above, the second probability is calculated as “0.000095” (to six decimal places), from “(2×0.0188171)×(1−e^{(-24/8760)})×(168−24/2)/168”. The contents of Formula 3 correspond to the contents described in the processes from S34 to S37.

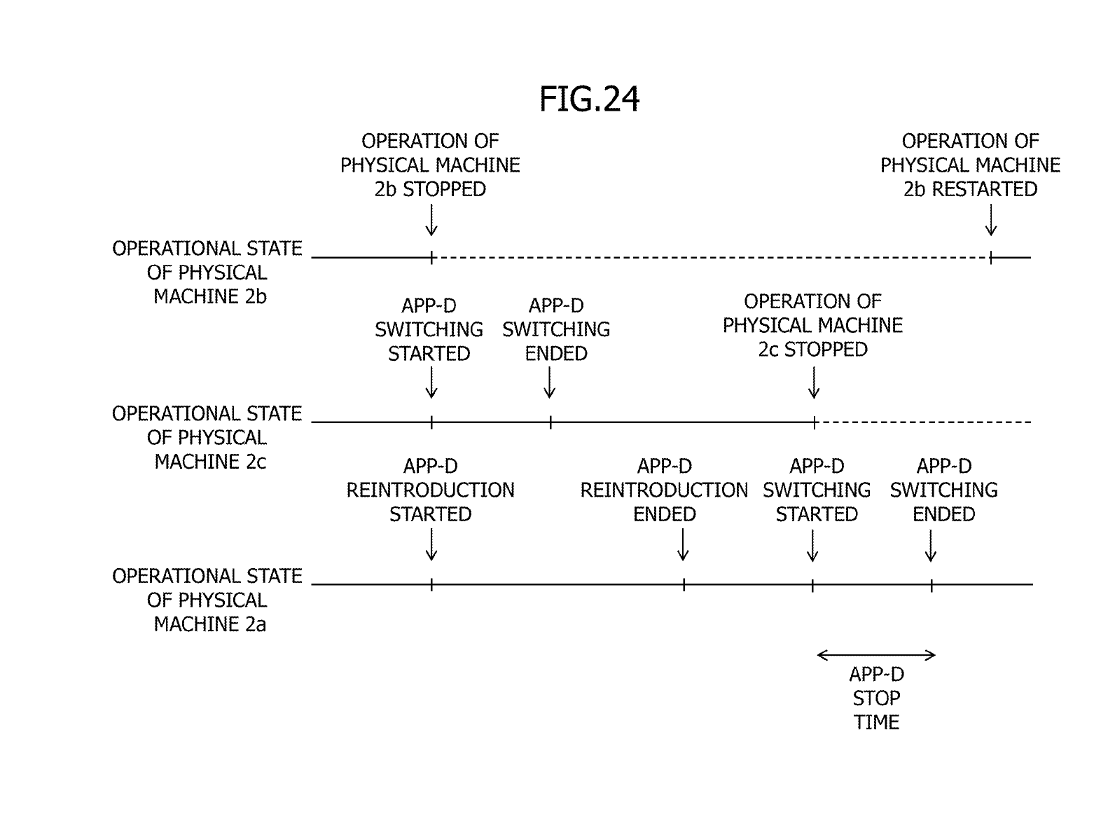

Next, the operating rate calculation unit 114 calculates the third probability (S41 to S45). FIG. 24 illustrates the third probability. The operating rate calculation unit 114 calculates the third probability which is the probability of APP-D stopping due to the physical machine 2c stopping after reintroduction to the physical machine 2a has been completed, as indicated by “APP-D stop time” in FIG. 24. More specifically, the third probability is calculated by formula 4 below.

third probability=number of physical machines into which new application has been introduced×a value obtained by raising failure rate R1 to the power of an exponent, subtracted by 1 from the number of physical machines, to which the new application has been introduced×(1−P)×(switching time information 137/(mean time to recovery information 136−reintroduction time T3)×(1−failure rate R1) (Formula 4)

Therefore, in the example illustrated in FIG. 18, from Formulas 2 and 4 above, the third probability is a value of “0.000002 (to six decimal places)” as calculated by (2×0.018817¹)×(1−1−e^{(-24/8760)})×(0.01/(168−24))×0.981183”. The contents of Formula 4 correspond to the contents described in the processes from S41 to S45.

Next, the operating rate calculation unit 114 calculates the fourth probability (S45). The fourth probability is calculated by Formula 5 below.

Fourth probability=a value obtained by raising failure rate R1 to the power of an exponent, added by 1 to number of physical machines, to which the new application has been introduced (Formula 5)

Therefore, in the example illustrated in FIG. 18, from Formula 5 above, the fourth probability is the value of “0.000006 (to six decimal places)” as calculated by “0.018817³”. The contents of Formula 5 correspond to the contents described in the process in S46.

Consequently, in the example illustrated in FIG. 18, the operating rate calculation unit 114 calculates, as the first operating rate R22, a value of “0.999896 (to six decimal places)” obtained by subtracting, from 1, “0.000001”, “0.000095”, “0.000002”, and “0.000006”.

The first operating rate R22 of “0.999896” is lower than the specified operating rate R21 of “0.9999” for the APP-D contained in the specification information 132 illustrated in FIG. 17. Therefore, in this case, the introduction determination unit 115 determines that it is not possible to introduce APP-D by an introduction method (first introduction method) corresponding to the information having an “information ID” of “3” in the introduction information 134 of FIG. 13 (S24).

In the examples described above, for example, when the first operating rate R22 is “0.99994”, the first operating rate R22 is greater than the specified operating rate R21 of “0.9999” for the APP-D contained in the specification information 132 illustrated in FIG. 17. Therefore, in this case, the introduction determination unit 115 determines that it is possible to introduce APP-D by an introduction method (first introduction method) corresponding to the information having an “information ID” of “3” in the introduction information 134 of FIG. 13 (S24).

The processing corresponding to the information having an “information ID” of “1” and “2” in the introduction information 134 in FIG. 13 is similar to that described above and further description thereof is omitted here.

[Specific Example of Creating Introduction Information 134]

Furthermore, the information management unit 112 may select one or more introduction methods that are to be included in the introduction information 134 when creating the introduction information 134. In this case, the information management unit 112, for example, calculates an operating rate R23 of the new application, respectively for each number of physical machines into which the new application may be introduced, on the basis of only the failure rate R1 of the physical machines included in the physical machine group 2. The information management unit 112 then identifies, from among the resulting operating rates R23 which exceed the specified operating rate R21, the operating rate R23 which involves the smallest number of physical machines into which the new application is introduced. Thereupon, the information management unit 112 creates introduction information 134 after excluding any introduction method which introduces the new application into a number of physical machines that is two or more fewer than the number of physical machines corresponding to the identified operating rate R23, for example.

More specifically, if the number of physical machines corresponding to the operating rate R23 is five, then the information management unit 112 creates introduction information 134 on the basis of only introduction methods which introduce the application into four or more physical machines. Consequently, the introduction determination unit 115 can swiftly determine whether or not it is possible to introduce a new application in accordance with each of the respective introduction methods.

Moreover, in creating the introduction information 134, the information management unit 112 may include information about the applications which have already been introduced into the physical machine group 2. The information management unit 112 then determines whether or not there is an application of which the first operating rate R22 would exceed the specified operating rate R21, even if the number of physical machines in which that application is actually introduced were to be reduced, from among the applications already introduced into the physical machine group 2. If, as a result of this, if there is an application for which it is possible to reduce the number of physical machines in which the application is introduced, then the information management unit 112 may create introduction information 134 based on the premise of reducing the number of physical machines into which that application has been introduced. Therefore, the information management unit 112 can ensure that applications already introduced into the physical machine group 2 are able to run efficiently as well.

From the perspective of stable operation of the business system, the information management unit 112 reduces the number of physical machines, into which each application is introduced, only when the number of physical machines, in which the already introduced applications are reduced, is equal to or lower than a prescribed threshold value.

In this way, the management device 1 receives the specification of a new application that is to be introduced into the physical machine group 2 which includes a plurality of physical machines, and an operating rate R21 for the new application. Furthermore, the management device 1 also acquires a first information amount that is required for introduction of the new application and processing after introduction, the respective failure rates R1 of the plurality of physical machines included in the physical machine group 2, and access performance relating to the storage devices of respective physical machines included in the physical machine group 2. The management device 1 then determines whether or not it is required to introduce the new application, respectively for each of the physical machines included in the physical machine group 2, on the basis of the contents of the received specification and the acquired information.

Accordingly, the management device 1 is able to guide the user in determining the introduction method for the new application.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium storing therein an introduction determination program that causes a computer to execute a process comprising:
receiving an application introduction specification including an application to be introduced into an information processing system and an operating rate for the application, the information processing system including a plurality of information processing devices; and
determining whether or not to introduce of the application for each of the plurality of the information processing devices, on the basis of the application introduction specification, a first information amount required for an introduction of the application or a post-processing after the introduction, respective failure rates of the plurality of information processing devices, and respective access performance, to respective storage devices, of the plurality of information processing devices.

2. The non-transitory computer-readable storage medium storing therein the introduction determination program according to claim 1, wherein
the access performance includes erasure performance, which is an amount of information that can be erased by the information processing device per unit time, and write performance, which is an amount of information that can be written by the information processing device per unit time,
the introduction determination program further that causes the computer to execute a process comprising:
identifying an information processing device in which the free capacity of the storage device is greater than the first information amount, from among the plurality of information processing devices, before the determining whether or not to introduce of the application; and
creating introduction information including information relating to one or more introduction methods in the case of introducing the application to the identified information processing device, and
the determining includes:
selecting a first introduction method which is one introduction method from among the one or more introduction methods for which information is included in the introduction information,
calculating respective reintroduction times for a case where the application has been introduced according to the selected first introduction method, and where one information processing device has failed among the information processing devices into which the application has been introduced and the application is reintroduced into an information processing device into which the application has not been introduced, the reintroduction times being times required for reintroduction of the application in the case of failures in the information processing devices into which the application has been introduced, on the basis of an information write time calculated by dividing the first information amount by the write performance and on the basis of an information erasure time calculated by dividing a second information amount by the erasure performance, the second information amount being an amount of information to be erased from the information processing device into which the application is reintroduced,
calculating a first operating rate, which is an operating rate of the application, on the basis of the respective failure rates of the plurality of information processing devices and the calculated reintroduction times, and
determining that introduction of the application in accordance with the first introduction method is possible, when the first operating rate is equal to or greater than the operating rate for the application contained in the application introduction specification.

3. The non-transitory computer-readable storage medium storing therein the introduction determination program according to claim 2, wherein
the second information amount is an amount of information equal to or greater than an amount of information obtained by subtracting, from the first amount of information, the amount of information that can be stored in the free capacity of the storage device of the information processing device to which the application is to be reintroduced.

4. The non-transitory computer-readable storage medium storing therein the introduction determination program according to claim 2, wherein
the information processing devices to which the application is introduced include a first information processing device, which is one information processing device that runs the application, and second information processing devices, which are one or more information processing devices which do not run the application unless the first information processing device has failed,
the calculating the first operating rate includes:
calculating a first probability which is a probability of complete stopping of the application introduced into the plurality of information processing devices due to failure of the first information processing device and running of the application in the second information processing device, on the basis of the respective failure rates of the plurality of information processing devices and the calculated reintroduction times,
calculating a second probability which is a probability of complete stopping of the application introduced into the plurality of information processing devices due to failure of all of the information processing devices, among the first and second information processing devices, other than a third information processing device which is one information processing device included in the first and second information processing devices, followed by failure of the third information processing device before reintroduction of the application has been completed,
calculating a third probability which is a probability of complete stopping of the application introduced into the plurality of information processing devices due to failure of all of the information processing devices, among the first and second information processing devices, other than the third information processing device, followed by failure of the third information processing device after reintroduction of the application has been completed, and running of the application in the information processing device into which the application has been reintroduced,
calculating a fourth probability which is a probability of complete stopping of the application introduced into the plurality of information processing devices due to failure of each of the first information processing device, the second information processing devices and the information processing device to which the application has been reintroduced, and
calculating, as the first operating rate of the application, a value obtained by subtracting the sum of the first probability, the second probability, the third probability and the fourth probability, from 1.

5. The non-transitory computer-readable storage medium storing therein the introduction determination program according to claim 4, wherein calculating the first probability includes calculating, as the first probability, a value obtained by multiplying the failure rate of the first information processing device; a ratio of a switching time require to run the application in the second information processing device with respect to a mean time to recovery in the event of failure of the first information processing device; and a value obtained by subtracting, from 1, a value obtained by multiplying the respective failure rates of the second information processing devices.

6. The non-transitory computer-readable storage medium storing therein the introduction determination program according to claim 4, wherein calculating the second probability includes calculating, as the second probability, a value obtained by multiplying the number of the first information processing device and the second information processing devices; a value obtained by multiplying the respective failure rates of the information processing devices other than the third information processing device, from among the first information processing device and the second information processing devices; the failure rate of the third information processing device after a failure of a fourth information processing device, which is an information processing device that has failed first among the first information processing device and the second information processing devices, and before the reintroduction time corresponding to the failure of the fourth information processing device has elapsed; and the ratio of the time obtained by subtracting, from the mean time to recovery of the fourth information processing device, a time obtained by dividing, by two, the reintroduction time corresponding to the failure of the fourth information processing device, with respect to the mean time to recovery of the fourth information processing device.

7. The non-transitory computer-readable storage medium storing therein the introduction determination program according to claim 4, wherein calculating the third probability includes calculating, as the third probability, a value obtained by multiplying the number of the first information processing device and the second information processing devices; a value obtained by multiplying the respective failure rates of the information processing devices other than the third information processing device, from among the first information processing device and the second information processing devices; a value obtained by subtracting, from 1, the failure rate of the third information processing device after a failure of a fourth information processing device, which an information processing device that has failed first among the first information processing device and the second information processing devices, and after the reintroduction time corresponding to the failure of the fourth information processing device has elapsed; a ratio of a switching time of the information processing device to which the application is reintroduced, with respect to a time obtained by subtracting the reintroduction time corresponding to the failure of the fourth information processing device from the mean time to recovery of the fourth information processing device; and a value obtained by subtracting, from 1, the failure rate of the information processing device into which the application is reintroduced.

8. The non-transitory computer-readable storage medium storing therein the introduction determination program according to claim 4, wherein calculating the fourth probability includes calculating, as the fourth probability, a value obtained by multiplying the failure rate of the first information processing device; a value obtained by multiplying the respective failure rates of the second information processing devices; and the failure rate of the information processing device to which the application is reintroduced.

9. The non-transitory computer-readable storage medium storing therein the introduction determination program according to claim 2, wherein the determining that introduction of the application is possible includes determining that introduction of the application in accordance with the first introduction method is impossible, when there is an information processing device in which a CPU usage rate would exceed a first threshold value, among the information processing devices to which the application is introduced in accordance with the first introduction method.

10. The non-transitory computer-readable storage medium storing therein the introduction determination program according to claim 2, wherein the determining that introduction of the application is possible includes determining that introduction of the application in accordance with the first introduction method is impossible, when there is an information processing device in which a communication load would exceed a second threshold value, among the information processing devices to which the application is introduced in accordance with the first introduction method.

11. An introduction judgment device, comprising:
a specification reception processor that receives an application introduction specification including an application to be introduced into an information processing system and an operating rate for the application, the information processing system including a plurality of information processing devices; and
an introduction determination processor that determines whether or not to introduce of the application for each of the plurality of the information processing devices, on the basis of the application introduction specification, a first information amount required for an introduction of the application or a post-processing after the introduction, respective failure rates of the plurality of information processing devices, and respective access performance, to respective storage devices, of the plurality of information processing devices.

12. An introduction determination method, comprising:
receiving, by a processor, an application introduction specification including an application to be introduced into an information processing system and an operating rate for the application, the information processing system including a plurality of information processing devices; and
determining, by a processor, whether or not to introduce of the application for each of the plurality of the information processing devices, on the basis of the application introduction specification, a first information amount required for an introduction of the application or a post-processing after the introduction, respective failure rates of the plurality of information processing devices, and respective access performance, to respective storage devices, of the plurality of information processing devices.
